(19) United States
(12) Patent Application Publication
(10) Pub. No.: US 2024/0426970 A1
(43) Pub. Date: Dec. 26, 2024

(54) JOINT COMMUNICATION AND SENSING USING RESOURCE ELEMENTS

(71) Applicant: QUALCOMM Incorporated, San Diego, CA (US)

(72) Inventors: Weimin DUAN, San Diego, CA (US); Hyojin LEE, San Diego, CA (US); Kangqi LIU, San Diego, CA (US); Jing JIANG, San Diego, CA (US)

(21) Appl. No.: 18/339,944

(22) Filed: Jun. 22, 2023

(51) Int. Cl. G01S 7/00; G01S 7/35; G01S 13/86; H04L 5/00

(52) U.S. Cl. CPC G01S 7/006; G01S 7/35; G01S 13/86; H04L 5/001

(57) ABSTRACT

Aspects of the disclosure involve multiplexing the transmission of communications signals and sensing signals at the resource element level. A frequency modulated continuous wave (FMCW) signal and plurality of orthogonal frequency-division multiplexing (OFDM) signals may be transmitted within an air interface frame structure having a plurality of resource elements, each resource element defined over a symbol duration in a time domain and a subcarrier in a frequency domain. The FMCW signal occupies a first plurality of resource elements and comprises a FMCW waveform repeated in the time domain and transmitted during a first symbol, over a first plurality of subcarriers of the air interface frame structure. The plurality of OFDM signals occupy a second plurality of resource elements in the air interface frame structure and are transmitted during the first symbol, over a second plurality of subcarriers of the air interface frame structure.

### BACKGROUND

### 1. Field of Disclosure

The present disclosure relates generally to the field of radio frequency (RF) sensing, and more specifically joint operation of wireless communications and RF sensing.

### 2. Description of Related Art

RF sensing broadly refers to the reception and use of reflected and/or emitted radio frequency (RF) radiation to determine one or more physical characteristics within an environment. Various physical characteristics may be determined, such as an object's range (i.e., distance away from a reference point), direction, position (e.g., relative position with respect to one or more reference point or absolute position within a given three-dimensional space), speed, velocity, etc. Radio detection and ranging (radar) is a type of RF sensing technology that uses the reflection of radio waves (e.g., RF signals) to determine characteristics such as the distance (ranging), angle, and/or radial velocity of one or more objects.

Wireless communication systems typically involve the use of RF signals to communicate data between or among two or more points, without the use of a physical conductor, such as a wire or cable. For example, data can be modulated onto a carrier signal which can be wirelessly propagated over distances from one point to one or more other points. Examples of wireless communications include those that utilize one or more base stations (BS) and user equipment (UE) that communicate with the base station(s). A type of wireless communication system that is widely used is one that that is commonly referred to as a 5th Generation (5G) New Radio (NR) communication system based on a standard defined by the 3rd Generation Partnership Project (3GPP).

Joint communications and sensing (JCS) has been identified as a potential capability for future wireless communication networks. By employing existing nodes such as base stations (BS) and user equipment (UE), RF sensing can be implemented without adding significant additional costs and take advantage of existing coverage areas already established for wireless communications. However, the inclusion of sensing capabilities in wireless communication networks presents many challenges.

### BRIEF SUMMARY

Aspects of the disclosure involve multiplexing the transmission of communications signals and sensing signals at the resource element level to achieve spectural efficiency. For example, a frequency modulated continuous wave (FMCW) signal may be transmitted as a sensing signal using resource elements corresponding to some sub-carrier frequencies in a given symbol period, while Orthogonal Frequency-Division Multiplexing (OFDM) signals are transmitted as communication signals using resource elements corresponding to other sub-carrier frequencies in the same symbol period. The FMCW signal and the OFDM signals may thus be transmitted simultaneously while being multiplexed in the frequency domain. The FMCW signal may comprise multiple cycles of a FMCW waveform during the symbol period, resulting in a comb-based structure for the sensing signal in the frequency domain.

Aspects of the disclosure involve a technique for transmitting signals for communication and sensing. The technique comprises transmitting, from a communication device, a frequency modulated continuous wave (FMCW) signal within an air interface frame structure having a plurality of resource elements, each resource element defined over a symbol duration in a time domain and a subcarrier in a frequency domain. The technique further comprises transmitting, from the communication device, a plurality of orthogonal frequency-division multiplexing (OFDM) signals within the air interface frame structure. The FMCW signal may occupy a first plurality of resource elements in the air interface frame structure and comprise a FMCW waveform repeated in the time domain and transmitted during a first symbol, over a first plurality of subcarriers of the air interface frame structure. The plurality of OFDM signals may occupy a second plurality of resource elements in the air interface frame structure and are transmitted during the first symbol, over a second plurality of subcarriers of the air interface frame structure.

Some aspects of the disclosure involve a device for transmitting signals for communication and sensing. The device comprises a memory, one or more processors coupled to the memory, a digital-to-analog (D/A) converter coupled to the one or more processors, and one or more antennas coupled to the D/A converter. The one or more processors may be configured to generate a digital signal comprising (1) a frequency modulated continuous wave (FMCW) signal within an air interface frame structure having a plurality of resource elements, each resource element defined over a symbol duration in a time domain and a subcarrier in a frequency domain, and (2) a plurality of orthogonal frequency-division multiplexing (OFDM) signals within the air interface frame structure. The FMCW signal may occupy a first plurality of resource elements in the air interface frame structure and comprise a FMCW waveform repeated in the time domain and transmitted during a first symbol, over a first plurality of subcarriers of the air interface frame structure. The plurality of OFDM signals may occupy a second plurality of resource elements in the air interface frame structure and is transmitted during the first symbol, over a second plurality of subcarriers of the air interface frame structure. The D/A converter may be configured generate an analog signal based on the digital signal. The one or more antennas may be configured to transmit a radio frequency (RF) signal based on the analog signal.

Other aspects of the disclosure involve another device for transmitting signals for communication and sensing. The device comprises a memory, one or more processors coupled to the memory, a digital-to-analog (D/A) converter coupled to the one or more processors, a frequency modulated continuous wave (FMCW) signal generator, a combiner coupled to the D/A converter and the FMCW signal generator, and one or more antennas coupled to the combiner. The FMCW signal generator may be configured to generate, as a first analog signal, a FMCW signal within an air interface frame structure having a plurality of resource elements, each resource element defined over a symbol duration in a time domain and a subcarrier in a frequency domain, the FMCW signal occupying a first plurality of resource elements in the air interface frame structure and comprising a FMCW waveform repeated in the time domain and transmitted during a first symbol, over a first plurality of subcarriers of the air interface frame structure. The one or more processors may be configured to generate, as a digital signal, a plurality of orthogonal frequency-division multiplexing (OFDM) signals within the air interface frame structure, the plurality of OFDM signals occupying a second plurality of resource elements in the air interface frame structure and is transmitted during the first symbol, over a second plurality of subcarriers of the air interface frame structure. The D/A converter may be configured to generate a second analog signal based on the digital signal. The combiner may be configured to generate a combined analog signal based on first analog signal and the second analog signal. The one or more antennas may be configured to transmit a radio frequency (RF) signal based on the combined analog signal.

Aspects of the disclosure involve a technique for receiving signals for communication and sensing. The technique comprises receiving, at a communication device, a frequency modulated continuous wave (FMCW) signal within an air interface frame structure having a plurality of resource elements, each resource element defined over a symbol duration in a time domain and a subcarrier in a frequency domain. The technique further comprises receiving, at the communication device, a plurality of orthogonal frequency-division multiplexing (OFDM) signals within the air interface frame structure. The technique further comprises generating, at the communication device, one or more of a range estimate, a Doppler estimate, and/or an Angle of Arrival (AoA) estimate based on the FMCW signal. The technique further comprises generating, at the communication device, demodulated data symbols based on the plurality of OFDM signals. The FMCW signal may occupy a first plurality of resource elements in the air interface frame structure and comprise a FMCW waveform repeated in the time domain and transmitted during a first symbol, over a first plurality of subcarriers of the air interface frame structure. The plurality of OFDM signals may occupy a second plurality of resource elements in the air interface frame structure and are transmitted during the first symbol, over a second plurality of subcarriers of the air interface frame structure.

Some aspects of the disclosure involve a device for receiving signals for communication and sensing. The device comprises one or more antennas, an analog-to-digital (A/D) converter coupled to the one or more antennas, one or more processors coupled to the A/D converter, and a memory coupled to the one or more processors. The one or more antennas may be configured to receive a radio frequency (RF) signal. The RF signal comprises (1) a frequency modulated continuous wave (FMCW) signal within an air interface frame structure having a plurality of resource elements, each resource element defined over a symbol duration in a time domain and a subcarrier in a frequency domain, and (2) a plurality of orthogonal frequency-division multiplexing (OFDM) signals within the air interface frame structure. The FMCW signal may occupy a first plurality of resource elements in the air interface frame structure and comprise a FMCW waveform repeated in the time domain and transmitted during a first symbol, over a first plurality of subcarriers of the air interface frame structure. The plurality of OFDM signals may occupy a second plurality of resource elements in the air interface frame structure and is transmitted during the first symbol, over a second plurality of subcarriers of the air interface frame structure. The A/D converter may be configured to generate a digital signal based on the RF signal. The one or more processors may be configured receive the digital signal and (1) generate one or more of a range estimate, a Doppler estimate, and/or an Angle of Arrival (AoA) estimate based on the FMCW signal as represented in the digital signal and (2) generate demodulated data symbols based on the plurality of OFDM signals as represented in the digital signal.

Other aspects of the disclosure involve another device for receiving signals for communication and sensing. The device comprise some or more antennas, a signal splitter, a frequency modulated continuous wave (FMCW) receiver coupled to the signal splitter, an analog-to-digital (A/D) converter coupled to the signal splitter, one or more processors coupled to the A/D converter, and a memory coupled to the one or more processors. The one or more antennas may be configured to receive a radio frequency (RF) signal, the RF signal comprising (1) a frequency modulated continuous wave (FMCW) signal within an air interface frame structure having a plurality of resource elements, each resource element defined over a symbol duration in a time domain and a subcarrier in a frequency domain, and (2) a plurality of orthogonal frequency-division multiplexing (OFDM) signals within the air interface frame structure. The FMCW signal may occupy a first plurality of resource elements in the air interface frame structure and comprises a FMCW waveform repeated in the time domain and transmitted during a first symbol, over a first plurality of subcarriers of the air interface frame structure. The plurality of OFDM signals may occupy a second plurality of resource elements in the air interface frame structure and is transmitted during the first symbol, over a second plurality of subcarriers of the air interface frame structure. The splitter may be configured to generate a first split signal and a second split signal based on the RF signal. The FMCW receiver may be configured to generate one or more of a range estimate, a Doppler estimate, and/or an Angle of Arrival (AoA) estimate based on the FMCW signal as represented in the first split signal. The A/D converter may be configured to generate a digital signal based on the second split signal. The one or more processors may be configured to generate demodulated data symbols based on the plurality of OFDM signals as represented in the digital signal.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a diagram of a positioning system, according to an embodiment.

FIG. 2 is a diagram of a 5th Generation (5G) New Radio (NR) positioning system, illustrating an embodiment of a positioning system (e.g., the positioning system of FIG. 1) implemented within a 5G NR communication network.

FIG. 3 is a diagram showing an example of how beamforming may be performed, according to some embodiments.

FIG. 4 is a diagram showing an example of a frame structure for NR and associated terminology.

FIG. 5 illustrates a simplified diagram of a RADAR system incorporated as part of a communications device, according to one or more embodiments.

FIG. 6 is a frequency-versus-time plot of a frequency modulated continuous wave (FMCW) TX signal, exhibiting characteristic “chirps,” according to an embodiment of the disclosure.

FIG. 7 is a frequency-versus-time plot of a FMCW TX signal and a received, reflected version of the same signal (i.e., FMCW RX signal).

FIG. 8 is a representation of an example of 2D range and Doppler estimation based on the received FMCW signal.

FIG. 9 illustrates an example of 5th Generation (5G) New Radio (NR) OFDM Numerology.

FIG. 10 illustrates an example of the operational capabilities of a commercially available FMCW radar transceiver.

FIGS. 11A and 11B present an example of a unified joint communications and sensing waveform design for resource-level frequency-division multiplexing of FMCW and OFDM signals incorporating an integer-duration cyclic prefix, according to some embodiments of the disclosure.

FIGS. 12A and 12B present an example of a unified joint communications and sensing waveform design for resource-level frequency-division multiplexing of FMCW and OFDM signals incorporating a fractional-duration cyclic prefix, according to some embodiments of the disclosure.

FIG. 13 presents a portion of a communication device implementing transmission of resource element (RE)-level frequency-division multiplexed (FDM) joint communication and sensing (JCS) signals using a single set of hardware for generating both FMCW and OFDM signals, according to some embodiments of the disclosure.

FIG. 14 presents a portion of a communication device implementing transmission of RE-level FDM multiplexed JCS signals using one set of hardware for generating FMCW signals and another set of hardware for generating OFDM signals, according to some embodiments of the disclosure.

FIG. 15 presents a portion of a communication device implementing reception of RE-level FDM multiplexed JCS signals using a single set of hardware for processing of both FMCW and OFDM signals, according to some embodiments of the disclosure.

FIG. 16 presents a portion of a communication device implementing reception of RE-level FDM multiplexed JCS signals using one set of hardware for processing of FMCW signals and another set of hardware for processing OFDM signals, according to some embodiments of the disclosure.

FIGS. 17A-17C illustrate the use of existing position reference signal (PRS) comb patterns for the transmission of FMCW signals for multi-device sensing, according to some embodiments of the disclosure.

FIG. 18A-18C illustrate the use of new, symmetric comb patterns for the transmission of FMCW signals for multi-device sensing, according to some embodiments of the disclosure.

FIG. 19 is a flow diagram of a method of transmitting signals for communication and sensing, according to an embodiment.

FIG. 20 is a flow diagram of a method of receiving signals for communication and sensing, according to an embodiment.

FIG. 21 is a block diagram of an embodiment of a UE, which can be utilized in embodiments as described herein.

FIG. 22 is a block diagram of an embodiment of a base station, which can be utilized in embodiments as described herein.

FIG. 23 is a block diagram of an embodiment of a computer system, which can be utilized in embodiments as described herein.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “reference signals,” “positioning reference signals,” “reference signals for positioning,” and the like may be used to refer to signals used for positioning of a user equipment (UE). As described in more detail herein, such signals may comprise any of a variety of signal types but may not necessarily be limited to a Positioning Reference Signal (PRS) as defined in relevant wireless standards.

Further, unless otherwise specified, the term “positioning” as used herein may absolute location determination, relative location determination, ranging, or a combination thereof. Such positioning may include and/or be based on timing, angular, phase, or power measurements, or a combination thereof (which may include RF sensing measurements) for the purpose of location or sensing services.

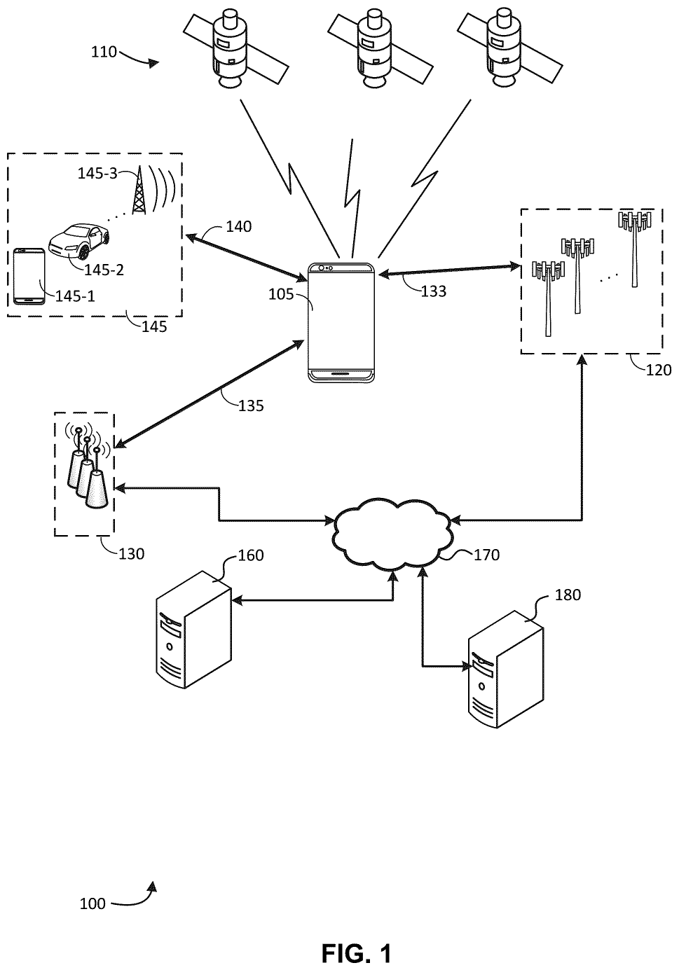

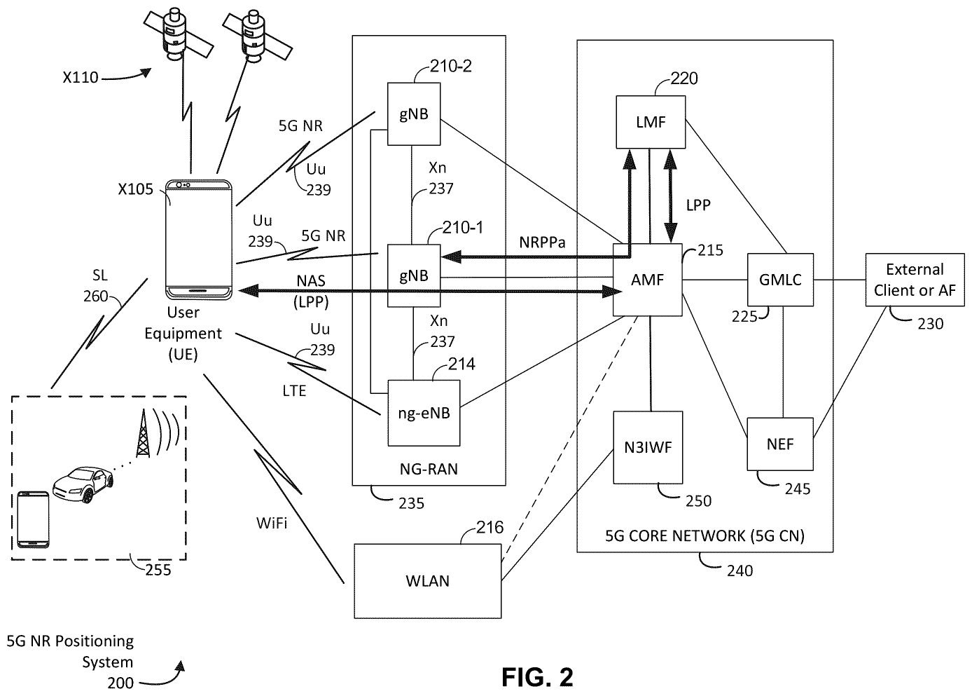

FIG. 1 is a simplified illustration of a positioning system 100 in which a UE 105, location server 160, and/or other components of the positioning system 100 can use the techniques provided herein for joint communication and sensing using resource elements, according to an embodiment. The techniques described herein may be implemented by one or more components of the positioning system 100. The positioning system 100 can include: a UE 105; one or more satellites 110 (also referred to as space vehicles (SVs)), which may include Global Navigation Satellite System (GNSS) satellites (e.g., satellites of the Global Positioning System (GPS), GLONASS, Galileo, Beidou, etc.) and/or Non-Terrestrial Network (NTN) satellites; base stations 120; access points (APs) 130; location server 160; network 170; and external client 180. Generally put, the positioning system 100 can estimate a location of the UE 105 based on RF signals received by and/or sent from the UE 105 and known locations of other components (e.g., GNSS satellites 110, base stations 120, APs 130) transmitting and/or receiving the RF signals. Additional details regarding particular location estimation techniques are discussed in more detail with regard to FIG. 2.

It should be noted that FIG. 1 provides only a generalized illustration of various components, any or all of which may be utilized as appropriate, and each of which may be duplicated as necessary. Specifically, although only one UE 105 is illustrated, it will be understood that many UEs (e.g., hundreds, thousands, millions, etc.) may utilize the positioning system 100. Similarly, the positioning system 100 may include a larger or smaller number of base stations 120 and/or APs 130 than illustrated in FIG. 1. The illustrated connections that connect the various components in the positioning system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUS), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, UE 105 can send and receive information with network-connected devices, such as location server 160, by accessing the network 170 via a base station 120 using a first communication link 133. Additionally or alternatively, because APs 130 also may be communicatively coupled with the network 170, UE 105 may communicate with network-connected and Internet-connected devices, including location server 160, using a second communication link 135, or via one or more other mobile devices 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP. Physical transmission points may comprise an array of antennas of a base station 120 (e.g., as in a Multiple Input-Multiple Output (MIMO) system and/or where the base station employs beamforming). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As used herein, the term “cell” may generically refer to a logical communication entity used for communication with a base station 120, and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

Satellites 110 may be utilized for positioning of the UE 105 in one or more ways. For example, satellites 110 (also referred to as space vehicles (SVs)) may be part of a Global Navigation Satellite System (GNSS) such as the Global Positioning System (GPS), GLONASS, Galileo or Beidou. Positioning using RF signals from GNSS satellites may comprise measuring multiple GNSS signals at a GNSS receiver of the UE 105 to perform code-based and/or carrier-based positioning, which can be highly accurate. Additionally or alternatively, satellites 110 may be utilized for NTN-based positioning, in which satellites 110 may functionally operate as TRPs (or TPs) of a network (e.g., LTE and/or NR network) and may be communicatively coupled with network 170. In particular, reference signals (e.g., PRS) transmitted by satellites 110 NTN-based positioning may be similar to those transmitted by base stations 120, and may be coordinated by a location server 160. In some embodiments, satellites 110 used for NTN-based positioning may be different than those used for GNSS-based positioning. In some embodiments NTN nodes may include non-terrestrial vehicles such as airplanes, balloons, drones, etc., which may be in addition or as an alternative to NTN satellites.

The location server 160 may comprise a server and/or other computing device configured to determine an estimated location of UE 105 and/or provide data (e.g., “assistance data”) to UE 105 to facilitate location measurement and/or location determination by UE 105. According to some embodiments, location server 160 may comprise a Home Secure User Plane Location (SUPL) Location Platform (H-SLP), which may support the SUPL user plane (UP) location solution defined by the Open Mobile Alliance (OMA) and may support location services for UE 105 based on subscription information for UE 105 stored in location server 160. In some embodiments, the location server 160 may comprise, a Discovered SLP (D-SLP) or an Emergency SLP (E-SLP). The location server 160 may also comprise an Enhanced Serving Mobile Location Center (E-SMLC) that supports location of UE 105 using a control plane (CP) location solution for LTE radio access by UE 105. The location server 160 may further comprise a Location Management Function (LMF) that supports location of UE 105 using a control plane (CP) location solution for NR or LTE radio access by UE 105.

In a CP location solution, signaling to control and manage the location of UE 105 may be exchanged between elements of network 170 and with UE 105 using existing network interfaces and protocols and as signaling from the perspective of network 170. In a UP location solution, signaling to control and manage the location of UE 105 may be exchanged between location server 160 and UE 105 as data (e.g. data transported using the Internet Protocol (IP) and/or Transmission Control Protocol (TCP)) from the perspective of network 170.

As previously noted (and discussed in more detail below), the estimated location of UE 105 may be based on measurements of RF signals sent from and/or received by the UE 105. In particular, these measurements can provide information regarding the relative distance and/or angle of the UE 105 from one or more components in the positioning system 100 (e.g., GNSS satellites 110, APs 130, base stations 120). The estimated location of the UE 105 can be estimated geometrically (e.g., using multiangulation and/or multilateration), based on the distance and/or angle measurements, along with known position of the one or more components.

Although terrestrial components such as APs 130 and base stations 120 may be fixed, embodiments are not so limited. Mobile components may be used. For example, in some embodiments, a location of the UE 105 may be estimated at least in part based on measurements of RF signals 140 communicated between the UE 105 and one or more other mobile devices 145, which may be mobile or fixed. As illustrated, other mobile devices may include, for example, a mobile phone 145-1, vehicle 145-2, static communication/positioning device 145-3, or other static and/or mobile device capable of providing wireless signals used for positioning the UE 105, or a combination thereof. Wireless signals from mobile devices 145 used for positioning of the UE 105 may comprise RF signals using, for example, Bluetooth® (including Bluetooth Low Energy (BLE)), IEEE 802.11x (e.g., Wi-Fi®), Ultra Wideband (UWB), IEEE 802.15x, or a combination thereof. Mobile devices 145 may additionally or alternatively use non-RF wireless signals for positioning of the UE 105, such as infrared signals or other optical technologies.

Mobile devices 145 may comprise other UEs communicatively coupled with a cellular or other mobile network (e.g., network 170). When one or more other mobile devices 145 comprising UEs are used in the position determination of a particular UE 105, the UE 105 for which the position is to be determined may be referred to as the “target UE,” and each of the other mobile devices 145 used may be referred to as an “anchor UE.” For position determination of a target UE, the respective positions of the one or more anchor UEs may be known and/or jointly determined with the target UE. Direct communication between the one or more other mobile devices 145 and UE 105 may comprise sidelink and/or similar Device-to-Device (D2D) communication technologies. Sidelink, which is defined by 3GPP, is a form of D2D communication under the cellular-based LTE and NR standards. UWB may be one such technology by which the positioning of a target device (e.g., UE 105) may be facilitated using measurements from one or more anchor devices (e.g., mobile devices 145).

According to some embodiments, such as when the UE 105 comprises and/or is incorporated into a vehicle, a form of D2D communication used by the mobile device 105 may comprise vehicle-to-everything (V2X) communication. V2X is a communication standard for vehicles and related entities to exchange information regarding a traffic environment. V2X can include vehicle-to-vehicle (V2V) communication between V2X-capable vehicles, vehicle-to-infrastructure (V2I) communication between the vehicle and infrastructure-based devices (commonly termed roadside units (RSUs)), vehicle-to-person (V2P) communication between vehicles and nearby people (pedestrians, cyclists, and other road users), and the like. Further, V2X can use any of a variety of wireless RF communication technologies. Cellular V2X (CV2X), for example, is a form of V2X that uses cellular-based communication such as LTE (4G), NR (5G) and/or other cellular technologies in a direct-communication mode as defined by 3GPP. The UE 105 illustrated in FIG. 1 may correspond to a component or device on a vehicle, RSU, or other V2X entity that is used to communicate V2X messages. In embodiments in which V2X is used, the static communication/positioning device 145-3 (which may correspond with an RSU) and/or the vehicle 145-2, therefore, may communicate with the UE 105 and may be used to determine the position of the UE 105 using techniques similar to those used by base stations 120 and/or APs 130 (e.g., using multiangulation and/or multilateration). It can be further noted that mobile devices 145 (which may include V2X devices), base stations 120, and/or APs 130 may be used together (e.g., in a WWAN positioning solution) to determine the position of the UE 105, according to some embodiments.

An estimated location of UE 105 can be used in a variety of applications—e.g. to assist direction finding or navigation for a user of UE 105 or to assist another user (e.g. associated with external client 180) to locate UE 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of UE 105 may comprise an absolute location of UE 105 (e.g. a latitude and longitude and possibly altitude) or a relative location of UE 105 (e.g. a location expressed as distances north or south, east or west and possibly above or below some other known fixed location (including, e.g., the location of a base station 120 or AP 130) or some other location such as a location for UE 105 at some known previous time, or a location of a mobile device 145 (e.g., another UE) at some known previous time). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which UE 105 is expected to be located with some level of confidence (e.g. 95% confidence).

The external client 180 may be a web server or remote application that may have some association with UE 105 (e.g. may be accessed by a user of UE 105) or may be a server, application, or computer system providing a location service to some other user or users which may include obtaining and providing the location of UE 105 (e.g. to enable a service such as friend or relative finder, or child or pet location). Additionally or alternatively, the external client 180 may obtain and provide the location of UE 105 to an emergency services provider, government agency, etc.

As previously noted, the example positioning system 100 can be implemented using a wireless communication network, such as an LTE-based or 5G NR-based network. FIG. 2 shows a diagram of a 5G NR positioning system 200, illustrating an embodiment of a positioning system (e.g., positioning system 100) implementing 5G NR. The 5G NR positioning system 200 may be configured to determine the location of a UE 105 by using access nodes, which may include NR NodeB (gNB) 210-1 and 210-2 (collectively and generically referred to herein as gNBs 210), ng-eNB 214, and/or WLAN 216 to implement one or more positioning methods. The gNBs 210 and/or the ng-eNB 214 may correspond with base stations 120 of FIG. 1, and the WLAN 216 may correspond with one or more access points 130 of FIG. 1. Optionally, the 5G NR positioning system 200 additionally may be configured to determine the location of a UE 105 by using an LMF 220 (which may correspond with location server 160) to implement the one or more positioning methods. Here, the 5G NR positioning system 200 comprises a UE 105, and components of a 5G NR network comprising a Next Generation (NG) Radio Access Network (RAN) (NG-RAN) 235 and a 5G Core Network (5G CN) 240. A 5G network may also be referred to as an NR network; NG-RAN 235 may be referred to as a 5G RAN or as an NR RAN; and 5G CN 240 may be referred to as an NG Core network.

The 5G NR positioning system 200 may further utilize information from satellites 110. As previously indicated, satellites 110 may comprise GNSS satellites from a GNSS system like Global Positioning System (GPS) or similar system (e.g. GLONASS, Galileo, Beidou, Indian Regional Navigational Satellite System (IRNSS)). Additionally or alternatively, satellites 110 may comprise NTN satellites that may be communicatively coupled with the LMF 220 and may operatively function as a TRP (or TP) in the NG-RAN 235. As such, satellites 110 may be in communication with one or more gNB 210.

It should be noted that FIG. 2 provides only a generalized illustration of various components, any or all of which may be utilized as appropriate, and each of which may be duplicated or omitted as necessary. Specifically, although only one UE 105 is illustrated, it will be understood that many UEs (e.g., hundreds, thousands, millions, etc.) may utilize the 5G NR positioning system 200. Similarly, the 5G NR positioning system 200 may include a larger (or smaller) number of satellites 110, gNBs 210, ng-eNBs 214, Wireless Local Area Networks (WLANs) 216, Access and mobility Management Functions (AMF) s 215, external clients 230, and/or other components. The illustrated connections that connect the various components in the 5G NR positioning system 200 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 105 may comprise and/or be referred to as a device, a mobile device, a wireless device, a mobile terminal, a terminal, a mobile station (MS), a Secure User Plane Location (SUPL)-Enabled Terminal (SET), or by some other name. Moreover, UE 105 may correspond to a cellphone, smartphone, laptop, tablet, personal data assistant (PDA), navigation device, Internet of Things (IoT) device, or some other portable or moveable device. Typically, though not necessarily, the UE 105 may support wireless communication using one or more Radio Access Technologies (RATs) such as using GSM, CDMA, W-CDMA, LTE, High Rate Packet Data (HRPD), IEEE 802.11 Wi-Fi®, Bluetooth, Worldwide Interoperability for Microwave Access (WiMAX™), 5G NR (e.g., using the NG-RAN 235 and 5G CN 240), etc. The UE 105 may also support wireless communication using a WLAN 216 which (like the one or more RATs, and as previously noted with respect to FIG. 1) may connect to other networks, such as the Internet. The use of one or more of these RATs may allow the UE 105 to communicate with an external client 230 (e.g., via elements of 5G CN 240 not shown in FIG. 2, or possibly via a Gateway Mobile Location Center (GMLC) 225) and/or allow the external client 230 to receive location information regarding the UE 105 (e.g., via the GMLC 225). The external client 230 of FIG. 2 may correspond to external client 180 of FIG. 1, as implemented in or communicatively coupled with a 5G NR network.

The UE 105 may include a single entity or may include multiple entities, such as in a personal area network where a user may employ audio, video and/or data I/O devices, and/or body sensors and a separate wireline or wireless modem. An estimate of a location of the UE 105 may be referred to as a location, location estimate, location fix, fix, position, position estimate, or position fix, and may be geodetic, thus providing location coordinates for the UE 105 (e.g., latitude and longitude), which may or may not include an altitude component (e.g., height above sea level, height above or depth below ground level, floor level or basement level). Alternatively, a location of the UE 105 may be expressed as a civic location (e.g., as a postal address or the designation of some point or small area in a building such as a particular room or floor). A location of the UE 105 may also be expressed as an area or volume (defined either geodetically or in civic form) within which the UE 105 is expected to be located with some probability or confidence level (e.g., 67%, 95%, etc.). A location of the UE 105 may further be a relative location comprising, for example, a distance and direction or relative X. Y (and Z) coordinates defined relative to some origin at a known location which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local X, Y, and possibly Z coordinates and then, if needed, convert the local coordinates into absolute ones (e.g. for latitude, longitude and altitude above or below mean sea level).

Base stations in the NG-RAN 235 shown in FIG. 2 may correspond to base stations 120 in FIG. 1 and may include gNBs 210. Pairs of gNBs 210 in NG-RAN 235 may be connected to one another (e.g., directly as shown in FIG. 2 or indirectly via other gNBs 210). The communication interface between base stations (gNBs 210 and/or ng-eNB 214) may be referred to as an Xn interface 237. Access to the 5G network is provided to UE 105 via wireless communication between the UE 105 and one or more of the gNBs 210, which may provide wireless communications access to the 5G CN 240 on behalf of the UE 105 using 5G NR. The wireless interface between base stations (gNBs 210 and/or ng-eNB 214) and the UE 105 may be referred to as a Uu interface 239. 5G NR radio access may also be referred to as NR radio access or as 5G radio access. In FIG. 2, the serving gNB for UE 105 is assumed to be gNB 210-1, although other gNBs (e.g. gNB 210-2) may act as a serving gNB if UE 105 moves to another location or may act as a secondary gNB to provide additional throughput and bandwidth to UE 105.

Base stations in the NG-RAN 235 shown in FIG. 2 may also or instead include a next generation evolved Node B, also referred to as an ng-eNB, 214. Ng-eNB 214 may be connected to one or more gNBs 210 in NG-RAN 235—e.g. directly or indirectly via other gNBs 210 and/or other ng-eNBs. An ng-eNB 214 may provide LTE wireless access and/or evolved LTE (eLTE) wireless access to UE 105. Some gNBs 210 (e.g. gNB 210-2) and/or ng-eNB 214 in FIG. 2 may be configured to function as positioning-only beacons which may transmit signals (e.g., Positioning Reference Signal (PRS)) and/or may broadcast assistance data to assist positioning of UE 105 but may not receive signals from UE 105 or from other UEs. Some gNBs 210 (e.g., gNB 210-2 and/or another gNB not shown) and/or ng-eNB 214 may be configured to function as detecting-only nodes may scan for signals containing, e.g., PRS data, assistance data, or other location data. Such detecting-only nodes may not transmit signals or data to UEs but may transmit signals or data (relating to, e.g., PRS, assistance data, or other location data) to other network entities (e.g., one or more components of 5G CN 240, external client 230, or a controller) which may receive and store or use the data for positioning of at least UE 105. It is noted that while only one ng-eNB 214 is shown in FIG. 2, some embodiments may include multiple ng-eNBs 214. Base stations (e.g., gNBs 210 and/or ng-eNB 214) may communicate directly with one another via an Xn communication interface. Additionally or alternatively, base stations may communicate directly or indirectly with other components of the 5G NR positioning system 200, such as the LMF 220 and AMF 215.

5G NR positioning system 200 may also include one or more WLANs 216 which may connect to a Non-3GPP InterWorking Function (N3IWF) 250 in the 5G CN 240 (e.g., in the case of an untrusted WLAN 216). For example, the WLAN 216 may support IEEE 802.11 Wi-Fi access for UE 105 and may comprise one or more Wi-Fi APs (e.g., APs 130 of FIG. 1). Here, the N3IWF 250 may connect to other elements in the 5G CN 240 such as AMF 215. In some embodiments, WLAN 216 may support another RAT such as Bluetooth. The N3IWF 250 may provide support for secure access by UE 105 to other elements in 5G CN 240 and/or may support interworking of one or more protocols used by WLAN 216 and UE 105 to one or more protocols used by other elements of 5G CN 240 such as AMF 215. For example, N3IWF 250 may support IPSec tunnel establishment with UE 105, termination of IKEv2/IPSec protocols with UE 105, termination of N2 and N3 interfaces to 5G CN 240 for control plane and user plane, respectively, relaying of uplink (UL) and downlink (DL) control plane Non-Access Stratum (NAS) signaling between UE 105 and AMF 215 across an N1 interface. In some other embodiments, WLAN 216 may connect directly to elements in 5G CN 240 (e.g. AMF 215 as shown by the dashed line in FIG. 2) and not via N3IWF 250. For example, direct connection of WLAN 216 to 5GCN 240 may occur if WLAN 216 is a trusted WLAN for 5GCN 240 and may be enabled using a Trusted WLAN Interworking Function (TWIF) (not shown in FIG. 2) which may be an element inside WLAN 216. It is noted that while only one WLAN 216 is shown in FIG. 2, some embodiments may include multiple WLANs 216.

Access nodes may comprise any of a variety of network entities enabling communication between the UE 105 and the AMF 215. As noted, this can include gNBs 210, ng-cNB 214, WLAN 216, and/or other types of cellular base stations. However, access nodes providing the functionality described herein may additionally or alternatively include entities enabling communications to any of a variety of RATs not illustrated in FIG. 2, which may include non-cellular technologies. Thus, the term “access node,” as used in the embodiments described herein below, may include but is not necessarily limited to a gNB 210, ng-eNB 214 or WLAN 216.

In some embodiments, an access node, such as a gNB 210, ng-eNB 214, and/or WLAN 216 (alone or in combination with other components of the 5G NR positioning system 200), may be configured to, in response to receiving a request for location information from the LMF 220, obtain location measurements of uplink (UL) signals received from the UE 105) and/or obtain downlink (DL) location measurements from the UE 105 that were obtained by UE 105 for DL signals received by UE 105 from one or more access nodes. As noted, while FIG. 2 depicts access nodes (gNB 210, ng-eNB 214, and WLAN 216) configured to communicate according to 5G NR, LTE, and Wi-Fi communication protocols, respectively, access nodes configured to communicate according to other communication protocols may be used, such as, for example, a Node B using a Wideband Code Division Multiple Access (WCDMA) protocol for a Universal Mobile Telecommunications Service (UMTS) Terrestrial Radio Access Network (UTRAN), an eNB using an LTE protocol for an Evolved UTRAN (E-UTRAN), or a Bluetooth® beacon using a Bluetooth protocol for a WLAN. For example, in a 4G Evolved Packet System (EPS) providing LTE wireless access to UE 105, a RAN may comprise an E-UTRAN, which may comprise base stations comprising eNBs supporting LTE wireless access. A core network for EPS may comprise an Evolved Packet Core (EPC). An EPS may then comprise an E-UTRAN plus an EPC, where the E-UTRAN corresponds to NG-RAN 235 and the EPC corresponds to 5GCN 240 in FIG. 2. The methods and techniques described herein for obtaining a civic location for UE 105 may be applicable to such other networks.

The gNBs 210 and ng-eNB 214 can communicate with an AMF 215, which, for positioning functionality, communicates with an LMF 220. The AMF 215 may support mobility of the UE 105, including cell change and handover of UE 105 from an access node (e.g., gNB 210, ng-eNB 214, or WLAN 216) of a first RAT to an access node of a second RAT. The AMF 215 may also participate in supporting a signaling connection to the UE 105 and possibly data and voice bearers for the UE 105. The LMF 220 may support positioning of the UE 105 using a CP location solution when UE 105 accesses the NG-RAN 235 or WLAN 216 and may support position procedures and methods, including UE assisted/UE based and/or network based procedures/methods, such as Assisted GNSS (A-GNSS), Observed Time Difference Of Arrival (OTDOA) (which may be referred to in NR as Time Difference Of Arrival (TDOA)), Frequency Difference Of Arrival (FDOA), Real Time Kinematic (RTK), Precise Point Positioning (PPP), Differential GNSS (DGNSS), Enhance Cell ID (ECID), angle of arrival (AoA), angle of departure (AoD), WLAN positioning, round trip signal propagation delay (RTT), multi-cell RTT, and/or other positioning procedures and methods. The LMF 220 may also process location service requests for the UE 105, e.g., received from the AMF 215 or from the GMLC 225. The LMF 220 may be connected to AMF 215 and/or to GMLC 225. In some embodiments, a network such as 5GCN 240 may additionally or alternatively implement other types of location-support modules, such as an Evolved Serving Mobile Location Center (E-SMLC) or a SUPL Location Platform (SLP). It is noted that in some embodiments, at least part of the positioning functionality (including determination of a UE 105's location) may be performed at the UE 105 (e.g., by measuring downlink PRS (DL-PRS) signals transmitted by wireless nodes such as gNBs 210, ng-eNB 214 and/or WLAN 216, and/or using assistance data provided to the UE 105, e.g., by LMF 220).

The Gateway Mobile Location Center (GMLC) 225 may support a location request for the UE 105 received from an external client 230 and may forward such a location request to the AMF 215 for forwarding by the AMF 215 to the LMF 220. A location response from the LMF 220 (e.g., containing a location estimate for the UE 105) may be similarly returned to the GMLC 225 either directly or via the AMF 215, and the GMLC 225 may then return the location response (e.g., containing the location estimate) to the external client 230.

A Network Exposure Function (NEF) 245 may be included in 5GCN 240. The NEF 245 may support secure exposure of capabilities and events concerning 5GCN 240 and UE 105 to the external client 230, which may then be referred to as an Access Function (AF) and may enable secure provision of information from external client 230 to 5GCN 240. NEF 245 may be connected to AMF 215 and/or to GMLC 225 for the purposes of obtaining a location (e.g. a civic location) of UE 105 and providing the location to external client 230.

As further illustrated in FIG. 2, the LMF 220 may communicate with the gNBs 210 and/or with the ng-eNB 214 using an NR Positioning Protocol annex (NRPPa) as defined in 3GPP Technical Specification (TS) 38.455. NRPPa messages may be transferred between a gNB 210 and the LMF 220, and/or between an ng-eNB 214 and the LMF 220, via the AMF 215. As further illustrated in FIG. 2, LMF 220 and UE 105 may communicate using an LTE Positioning Protocol (LPP) as defined in 3GPP TS 37.355. Here, LPP messages may be transferred between the UE 105 and the LMF 220 via the AMF 215 and a serving gNB 210-1 or serving ng-eNB 214 for UE 105. For example, LPP messages may be transferred between the LMF 220 and the AMF 215 using messages for service-based operations (e.g., based on the Hypertext Transfer Protocol (HTTP)) and may be transferred between the AMF 215 and the UE 105 using a 5G NAS protocol. The LPP protocol may be used to support positioning of UE 105 using UE assisted and/or UE based position methods such as A-GNSS, RTK, TDOA, multi-cell RTT. AoD, and/or ECID. The NRPPa protocol may be used to support positioning of UE 105 using network based position methods such as ECID, AoA, uplink TDOA (UL-TDOA) and/or may be used by LMF 220 to obtain location related information from gNBs 210 and/or ng-eNB 214, such as parameters defining DL-PRS transmission from gNBs 210 and/or ng-eNB 214.

In the case of UE 105 access to WLAN 216, LMF 220 may use NRPPa and/or LPP to obtain a location of UE 105 in a similar manner to that just described for UE 105 access to a gNB 210 or ng-eNB 214. Thus, NRPPa messages may be transferred between a WLAN 216 and the LMF 220, via the AMF 215 and N3IWF 250 to support network-based positioning of UE 105 and/or transfer of other location information from WLAN 216 to LMF 220. Alternatively, NRPPa messages may be transferred between N3IWF 250 and the LMF 220, via the AMF 215, to support network-based positioning of UE 105 based on location related information and/or location measurements known to or accessible to N3IWF 250 and transferred from N3IWF 250 to LMF 220 using NRPPa. Similarly. LPP and/or LPP messages may be transferred between the UE 105 and the LMF 220 via the AMF 215, N3IWF 250, and serving WLAN 216 for UE 105 to support UE assisted or UE based positioning of UE 105 by LMF 220, described in more detail hereafter.

Positioning of the UE 205 in a 5G NR positioning system 200 further may utilize measurements between the UE 205 and one or more other UEs 255 via a sidelink connection SL 260. As shown in FIG. 2, the one or more other UEs 255 may comprise any of a variety of different device types, including mobile phones, vehicles, roadside units (RSUs), other device types, or any combination thereof. One or more position measurement signals sent via SL 260 to the UE 205 from the one or more other UEs 255, to the one or more other UEs 255 from the UE 205, or both. Various signals may be used for position measurement, including sidelink PRS (SL-PRS). In some instances, the position of at least one of the one or more of the other UEs 255 may be determined at the same time (e.g., in the same positioning session) as the position of the UE 205. In some embodiments, the LMF 220 may coordinate the transmission of positioning signals via SL 260 between the UE 205 and the one or more other UEs 255. Additionally or alternatively, the UE 205 and the one or more other UEs 255 may coordinate a positioning session between themselves, without an LMF 220 or even a Uu connection 239 to an access node of the NG-RAN 235. To do so, the UE 205 and the one or more other UEs 255 may communicate messages via the SL 260 using sidelink positioning protocol (SLPP). In some scenarios, the one or more other UEs 255 may have a Uu connection 239 with an access node of the NG-RAN 235 and/or Wi-Fi connection with WLAN 216 when the UE 205 does not. In such instances, the one or more other UEs 255 may operate as relay devices, relaying communications to the network (e.g., LMF 220) from the UE 205. In such instances, a plurality of other UEs 255 may form a chain between the UE 205 and the access node.

In a 5G NR positioning system 200, positioning methods can be categorized as being “UE assisted” or “UE based.” This may depend on where the request for determining the position of the UE 105 originated. If, for example, the request originated at the UE (e.g., from an application, or “app,” executed by the UE), the positioning method may be categorized as being UE based. If, on the other hand, the request originates from an external client 230, LMF 220, or other device or service within the 5G network, the positioning method may be categorized as being UE assisted (or “network-based”).

With a UE-assisted position method, UE 105 may obtain location measurements and send the measurements to a location server (e.g., LMF 220) for computation of a location estimate for UE 105. For RAT-dependent position methods location measurements may include one or more of a Received Signal Strength Indicator (RSSI), Round Trip signal propagation Time (RTT), Reference Signal Received Power (RSRP), Reference Signal Received Quality (RSRQ), Reference Signal Time Difference (RSTD), Time of Arrival (TOA), AoA, Receive Time-Transmission Time Difference (Rx-Tx), Differential AoA (DAOA), AoD, or Timing Advance (TA) for gNBs 210, ng-eNB 214, and/or one or more access points for WLAN 216. Additionally or alternatively, similar measurements may be made of sidelink signals transmitted by other UEs, which may serve as anchor points for positioning of the UE 105 if the positions of the other UEs are known. The location measurements may also or instead include measurements for RAT-independent positioning methods such as GNSS (e.g., GNSS pseudorange, GNSS code phase, and/or GNSS carrier phase for satellites 110), WLAN, etc.

With a UE-based position method, UE 105 may obtain location measurements (e.g., which may be the same as or similar to location measurements for a UE assisted position method) and may further compute a location of UE 105 (e.g., with the help of assistance data received from a location server such as LMF 220, an SLP, or broadcast by gNBs 210, ng-eNB 214, or WLAN 216).

With a network based position method, one or more base stations (e.g., gNBs 210 and/or ng-eNB 214), one or more APs (e.g., in WLAN 216), or N3IWF 250 may obtain location measurements (e.g., measurements of RSSI, RTT, RSRP. RSRQ, AoA, or TOA) for signals transmitted by UE 105, and/or may receive measurements obtained by UE 105 or by an AP in WLAN 216 in the case of N3IWF 250, and may send the measurements to a location server (e.g., LMF 220) for computation of a location estimate for UE 105.

Positioning of the UE 105 also may be categorized as UL, DL, or DL-UL based, depending on the types of signals used for positioning. If, for example, positioning is based solely on signals received at the UE 105 (e.g., from a base station or other UE), the positioning may be categorized as DL based. On the other hand, if positioning is based solely on signals transmitted by the UE 105 (which may be received by a base station or other UE, for example), the positioning may be categorized as UL based. Positioning that is DL-UL based includes positioning, such as RTT-based positioning, that is based on signals that are both transmitted and received by the UE 105. Sidelink (SL)-assisted positioning comprises signals communicated between the UE 105 and one or more other UEs. According to some embodiments, UL, DL, or DL-UL positioning as described herein may be capable of using SL signaling as a complement or replacement of SL, DL, or DL-UL signaling.

Depending on the type of positioning (e.g., UL, DL, or DL-UL based) the types of reference signals used can vary. For DL-based positioning, for example, these signals may comprise PRS (e.g., DL-PRS transmitted by base stations or SL-PRS transmitted by other UEs), which can be used for TDOA, AoD, and RTT measurements. Other reference signals that can be used for positioning (UL, DL, or DL-UL) may include Sounding Reference Signal (SRS), Channel State Information Reference Signal (CSI-RS), synchronization signals (e.g., synchronization signal block (SSB) Synchronizations Signal (SS)), Physical Uplink Control Channel (PUCCH), Physical Uplink Shared Channel (PUSCH), Physical Sidelink Shared Channel (PSSCH), Demodulation Reference Signal (DMRS), etc. Moreover, reference signals may be transmitted in a Tx beam and/or received in an Rx beam (e.g., using beamforming techniques), which may impact angular measurements, such as AoD and/or AoA.

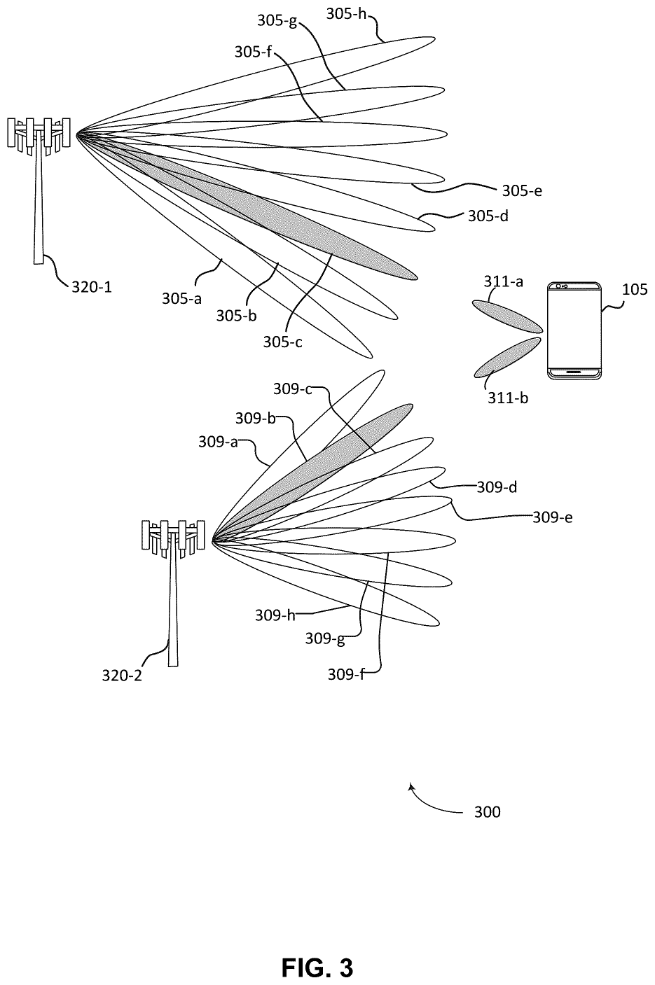

FIG. 3 is a diagram illustrating a simplified environment 300 including two base stations 320-1 and 320-2 (which may correspond to base stations 120 of FIG. 1 and/or gNBs 210 and/or ng-eNB 214 of FIG. 2) with antenna arrays that can perform beamforming to produce directional beams for transmitting and/or receiving RF signals. FIG. 3 also illustrates a UE 105, which may also use beamforming for transmitting and/or receiving RF signals. Such directional beams are used in 5G NR wireless communication networks. Each directional beam may have a beam width centered in a different direction, enabling different beams of a base station 320 to correspond with different areas within a coverage area for the base station 320.

Different modes of operation may enable base stations 320-1 and 320-2 to use a larger or smaller number of beams. For example, in a first mode of operation, a base station 320 may use 16 beams, in which case each beam may have a relatively wide beam width. In a second mode of operation, a base station 320 may use 64 beams, in which case each beam may have a relatively narrow beam width. Depending on the capabilities of a base station 320, the base station may use any number of beams the base station 320 may be capable of forming. The modes of operation and/or number of beams may be defined in relevant wireless standards and may correspond to different directions in either or both azimuth and elevation (e.g., horizontal and vertical directions). Different modes of operation may be used to transmit and/or receive different signal types. Additionally or alternatively, the UE 105 may be capable of using different numbers of beams, which may also correspond to different modes of operation, signal types, etc.

In some situations, a base station 320 may use beam sweeping. Beam sweeping is a process in which the base station 320 may send an RF signal in different directions using different respective beams, often in succession, effectively “sweeping” across a coverage area. For example, a base station 320 may sweep across 120 or 360 degrees in an azimuth direction, for each beam sweep, which may be periodically repeated. Each direction beam can include an RF reference signal (e.g., a PRS resource), where base station 320-1 produces a set of RF reference signals that includes Tx beams 305-a, 305-b, 305-c, 305-d, 305-e, 305-f, 305-g, and 305-h, and the base station 320-2 produces a set of RF reference signals that includes Tx beams 309-a, 309-b, 309-c, 309-d. 309-e, 309-f, 309-g, and 309-h. As noted, because UE 105 may also include an antenna array, it can receive RF reference signals transmitted by base stations 320-1 and 320-2 using beamforming to form respective receive beams (Rx beams) 311-a and 311-b. Beamforming in this manner (by base stations 320 and optionally by UEs 105) can be used to make communications more efficient. They can also be used for other purposes, including taking measurements for position determination (e.g., AoD and AoA measurements).

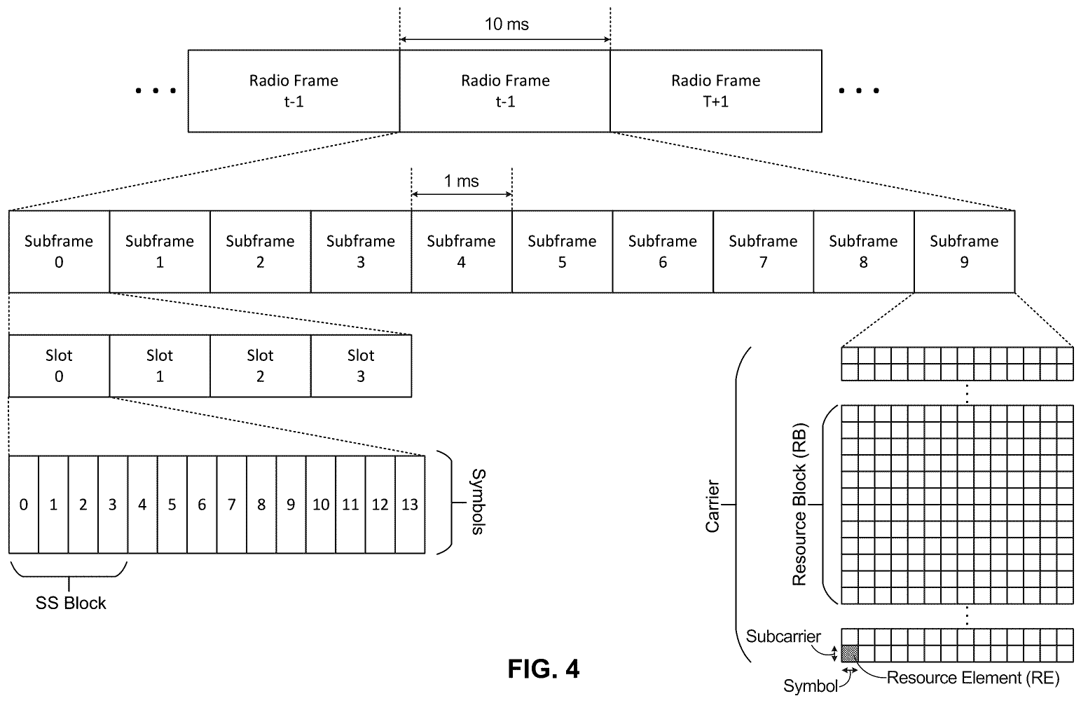

FIG. 4 is a diagram showing an example of a frame structure for NR and associated terminology, which can serve as the basis for physical layer communication between the UE 105 and base stations/TRPs. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots depending on the subcarrier spacing. Each slot may include a variable number of symbol periods (e.g., 7 or 14 symbols) depending on the subcarrier spacing. The symbol periods in each slot may be assigned indices. A mini slot may comprise a sub slot structure (e.g., 2, 3, or 4 symbols). Additionally shown in FIG. 4 is the complete Orthogonal Frequency-Division Multiplexing (OFDM) of a subframe, showing how a subframe can be divided across both time and frequency into a plurality of Resource Blocks (RBs). A single RB can comprise a grid of Resource Elements (REs) spanning 14 symbols and 12 subcarriers.

Each symbol in a slot may indicate a link direction (e.g., downlink (DL), uplink (UL), or flexible) or data transmission and the link direction for each subframe may be dynamically switched. The link directions may be based on the slot format. Each slot may include DL/UL data as well as DL/UL control information. In NR, a synchronization signal (SS) block is transmitted. The SS block includes a primary SS (PSS), a secondary SS (SSS), and a two symbol Physical Broadcast Channel (PBCH). The SS block can be transmitted in a fixed slot location, such as the symbols 0-3 as shown in FIG. 4. The PSS and SSS may be used by UEs for cell search and acquisition. The PSS may provide half-frame timing, the SS may provide the cyclic prefix (CP) length and frame timing. The PSS and SSS may provide the cell identity. The PBCH carries some basic system information, such as downlink system bandwidth, timing information within radio frame, SS burst set periodicity, system frame number, etc.

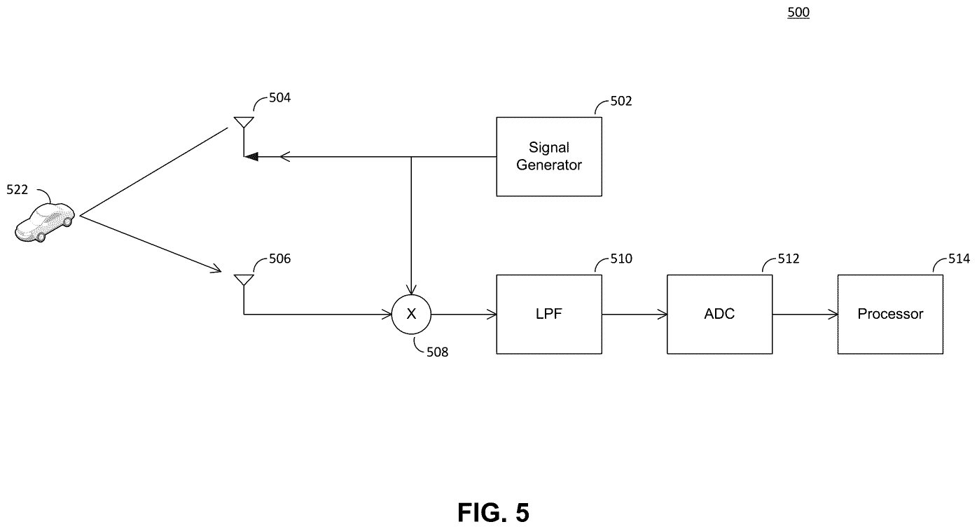

FIG. 5 illustrates a simplified diagram of an example of an RF sensing system, in the form of a RADAR system 500, incorporated as part of a communications device such as a base station or a UE according to one or more embodiments. The communications functionality (e.g., OFDM transmission and reception) is not explicitly shown, in order to highlight the RF sensing functionality presented in this figure. RADAR system 500 may operate to obtain range, direction of arrival (DoA), velocity, and/or other information pertaining to a target 522. In the embodiment shown in the figure, RADAR system 500 may comprise a signal generator 502, a transmit (TX) antenna 504, a receive (RX) antenna 506, a mixer 508, a low pass filter (LPF) 510, an analog-to-digital converter (ADC) 512, and a processor 514. While only one target 522 is shown for simplicity of illustration, it is contemplated that RADAR system 500 may obtain range, velocity, angle estimation, and/or other information pertaining to more than one target. Also, while a monostatic RADAR system is illustrated in this figure, a bi-static or multi-static RADAR system may also incorporate the features of the present disclosure.

Referring to FIG. 5, signal generator 502 generates a RADAR TX signal, which is provided to TX antenna 504. Transmit antenna 104 may transmit the RADAR TX signal toward target 522. The signal reflects off of one or more surfaces of target 522, and the reflected signal reaches RX antenna 506 after a time delay, which is proportional to the roundtrip distance between system 500 and target 522 as well as the speed of the signal, generally calculated as the speed of light, c. The received signal from RX antenna, often referred to as the radio frequency (RF) signal, is provided to one input of mixer 508. A local version of the RADAR TX signal is provided to another input of mixer 508. Mixer 508 performs a signal multiplication operation on (“mixes”) the two input signals and generates an output signal. In other words, the received RF signal, which has experienced the roundtrip delay, is mixed down using the local version of the same signal. Mixer 508 outputs the resulting mixed down signal, often referred to as the intermediate frequency (IF) signal. LPF 510, which may be characterized by a cutoff frequency, is then used to filter the IF signal, to generate a low pass-filtered signal. ADC 512 is then used to sample and digitize the low pass-filtered signal, to generate a digital signal that represents the IF signal. The digital signal is then provided to processor 514, which can perform further downstream processing to eventually generate information relating to target 522 such as range, velocity, and direction-of-arrival (DoA) estimations.

While not shown in this figure, RADAR system 500 may include more than one set of RX components, such as RX antennas, in order to perform angle-of-arrival estimation. For example, the collection of RX components comprising receive antenna 506, mixer 508, LPF 510, and ADC 512 may together form one RX processing chain. Multiple instances of such RX processing chain may be included in RADAR system 500 to generate multiple ADC outputs, which may be provided to processor 514, to facilitate DoA estimations.

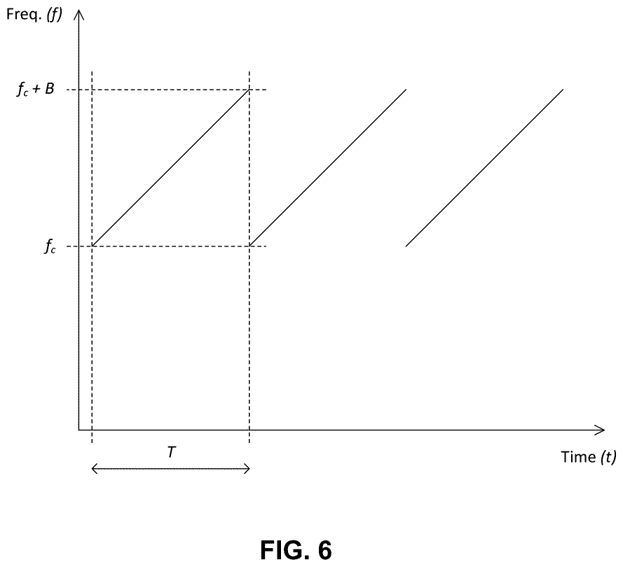

FIG. 6 is a frequency-versus-time plot of a frequency modulated continuous wave (FMCW) TX signal, exhibiting characteristic “chirps,” according to an embodiment of the disclosure. An FMCW waveform is a complex sinusoid whose frequency increases linearly with time. The frequency of the FMCW signal may be expressed as:

$${f}_{t} = {f}_{c} + ( \frac{B}{T} ) * t \qquad ( Eq . 1 )$$

where f_{c} is the carrier frequency, B is the signal bandwidth, and tϵ[0,T]. The y-axis represents frequency amplitude, and the x-axis represents time. Each chirp is a continuous wave (e.g., sinusoidal) signal with an instantaneous frequency that changes over time, hence the name frequency-modulated, continuous wave signal. In this particular example, the frequency increases as a linear function of time. Other types of FMCW signals are possible, including “chirps” whose frequency linearly decrease over time, “saw tooth” signals whose frequency alternate between linearly increasing and linearly decreasing over time, etc. Also, while an FMCW signal is illustrated in this figure, the techniques presented in the present disclosure may be applicable to other types of RADAR TX signals, including other types of continuous wave (CW) signals, depending on the environment to be accommodated and the performance characteristics desired.

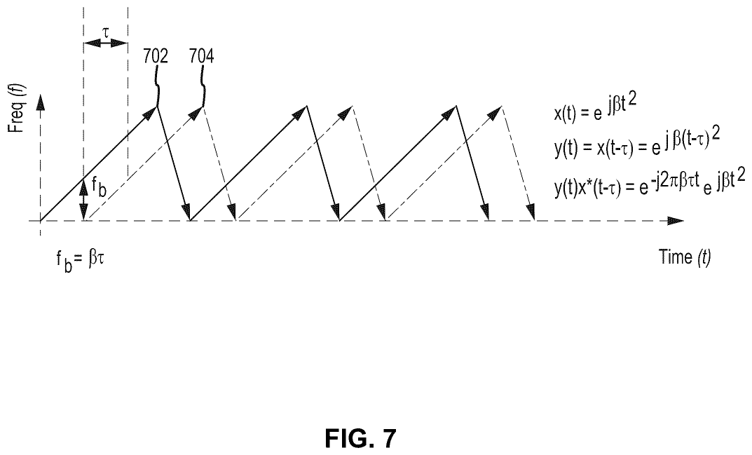

FIG. 7 is a frequency-versus-time plot of a FMCW TX signal 702 and a received, reflected version of the same signal (i.e., FMCW RX signal 704). Again, the y-axis represents frequency amplitude, and the x-axis represents time. The FMCW TX signal 702 may be expressed as:

$$x ( t ) = {e}^{j β {t}^{2}} \qquad ( Eq . 2 )$$

The FMCW RX signal 704 may be expressed as:

$$y ( t ) = x ( t - τ ) = {e}^{j {β ( t - τ )}^{2}} \qquad ( Eq . 3 )$$

Here, β represents the slope of the change in frequency over change in time of the FMCW waveform

$$( i . e , β = \frac{Δ f}{Δ t} ) .$$

The time delay τ represents the relative delay between the FMCW TX signal 302 and the FMCW RX signal 304.

The output of mixer 508 in FIG. 5 is the result of mixing the FMCW TX signal 702 and FMCW RX signal 704. This resulting signal may also be referred to as the IF signal, as discussed previously. The IF signal can be expressed as:

$$y ( t ) x * ( t ) = {e}^{j 2 πβτ t} {e}^{j {βτ}^{2}} \qquad ( Eq . 4 )$$

The IF signal may exhibit a “beat” frequency f_{b}=βτ. Typically, if the IF signal is sampled into a digitized format, a Fast Fourier Transform (FFT) may be performed on the IF signal to convert it into the frequency domain. This may be referred to as performing a “range transform.” Each peak in the output of the range transform may represent a “beat” frequency f_{b}. Note that the beat frequency, expressed as f_{b}=βτ, is directly related to the time delay τ between the FMCW TX signal 702 and the FMCW RX signal 704. Based on this relationship, the RADAR system 500 can use the range spectrum to detect the distance to the target, by determining the beat frequency f_{b}, then determining the time delay τ, and finally determining the roundtrip distance of the reflected path traveled by the signal (by taking into account the known propagation speed of the signal, e.g., the speed of light, c). There may be multiple beat frequencies f_{b} observed in the IF signal. Each beat frequency f_{b} may correspond to one or more potential targets located at the detected range (i.e., distance) indicated by the beat frequency. Thus, extracting the beat frequency f_{b} corresponds to performing the “range” estimate on the received RADAR signal.

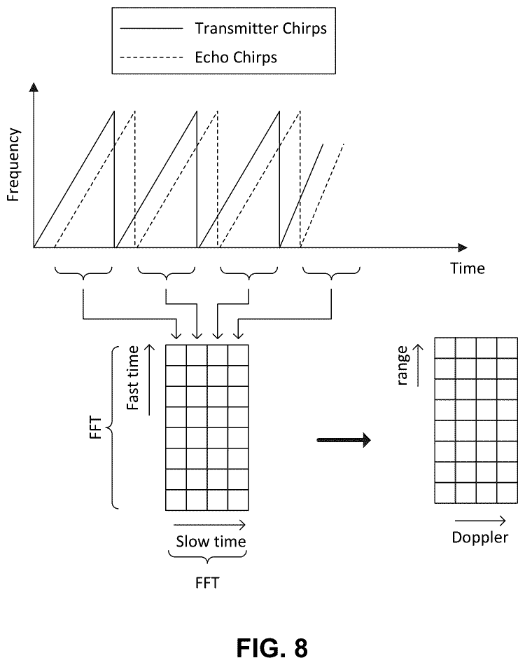

FIG. 8 is a representation of an example of 2D range and Doppler estimation based on the received FMCW signal. As illustrated in FIG. 5, the process of obtaining the beat signal is implemented in the radio frequency domain by a mixer (e.g., mixer 508), followed by a bandpass or lowpass filter (e.g., LPF 510). The beat signal frequency equals f_{b}=f_{R}+f_{D}, where f_{R}=2*R*B/(T*c) is the range frequency and f_{D}=(2v/c)*f_{c} is the Doppler frequency. Here, R is the target range, c is the speed of light and v is the radial speed of the target. The estimation of the beat frequency could be implemented in the digital domain through 2-D FFT. It holds that (2*Rₘₐₓ/c)<<T, and thus f_{R}<<B (Rₘₐₓ is the maximum detected range). Also, it typically holds that f_{D}<<f_{R}. Hence the beat frequency is much smaller than signal bandwidth B. Therefore, a low-speed (and therefore low-cost) ADC can be used to sample the beat signal. For example, a low-cost may have a sampling frequency in the hundreds (100s) of MHz to ten (10) or tens (10s) of MHz.

FIG. 8 shows how the result of mixing the transmitted chirps with the corresponding reflected (echo) chirps can be processed digitally to generate range, velocity, and potentially spatial information regarding one or more targets. The result of mixing the echo chirp with the transmitted chirp is obtained in digital form from the ADC and stored in a frame structure. The time during one period or chirp is usually referred to as the “fast time,” while the time across multiple periods chirps is referred to as the “slow time.” Specifically, an FFT performed on sampled data from the mixer for a chirp results in a range-FFT. Each range-FFT is thus arranged along the “fast-time” axis. In most use cases, f_{D} can be treated as constant within each chirp. Hence the FFTs on the beat signal along the fast time can identify the range frequency f_{R} and the corresponding target's range R=c*f_{R}*T/(2B).

Along a second dimension, A Doppler-FFT can performed across range-FFTs for different chirps to obtain an estimate of the velocity of the target(s). A second FFT operation along the slow time (assuming the range frequency f_{R} is the same across the slow time) could obtain the target's Doppler. Each Doppler-FFT is thus arranged along the slow-time axis. The range-FFTs and Doppler-FFTs form a two-dimensional (2D) FFT result. Along a third dimensions, a spatial-FFT can be performed across a stack of 2D FFTs obtained from different versions of the signal received at spatially distinct positions (e.g., multiple antennas) to obtain an estimate of the angle-of-arrival (AoA) of the target(s). Taking the spatial-FFT along the third dimension generates a 3D FFT structure (not explicitly shown) that is also referred to as a 3D FFT cube.

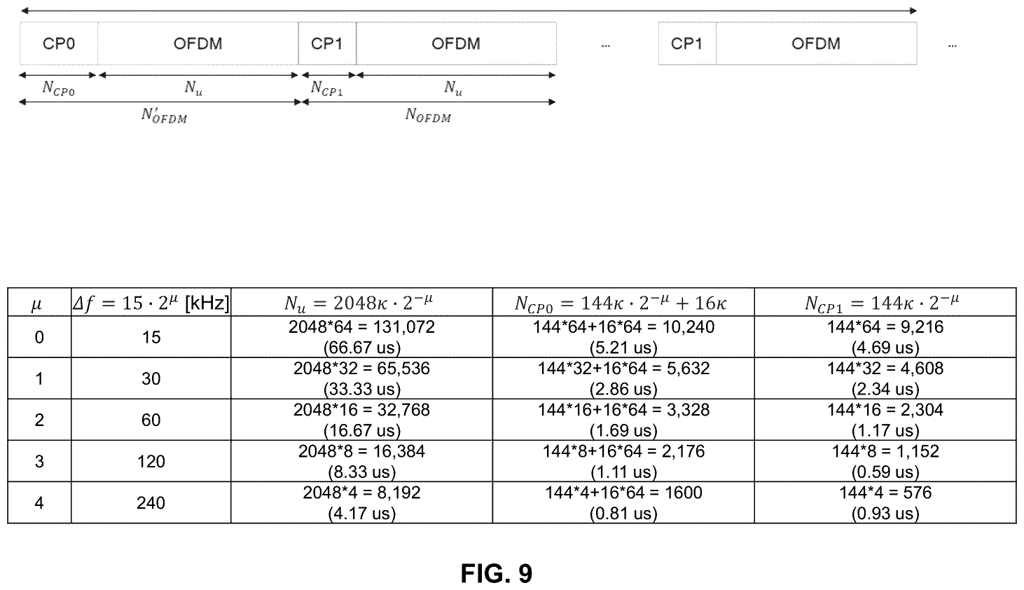

FIG. 9 illustrates an example of 5th Generation (5G) New Radio (NR) OFDM Numerology. Multiplexing of RF sensing signals with signals for communications, e.g., FMCW and OFDM signals, takes into account the timing and frequency structures of the two types of signals. The NR OFDM numerology presented in the present figure shows particular timing characteristics of an OFDM signal with a cyclic prefix (CP) portions positioned before each OFDM portion in time. The cyclic prefix portions including an initial cyclic prefix portion C0 and one or more subsequent cyclic prefix portions CP1. In this NR numerology example, the chip period is defined as Tc=1/(Δfₘₐₓ*N_{f})=0.59 nanosecond (ns), where the maximum subcarrier spacing Δfₘₐₓ=480 KHz, with N_{f}=4096, and k=64.

The duration (in time) of each OFDM portion and cyclic prefix portion may be defined in units of number of chips (N). The symbol length N_{OFDM} (in chips) corresponds to T_{OFDM} (in time) equals to 0.5 milliseconds (ms) in this case. The duration of the OFDM portion may be expressed as Nᵤ. The duration of the CP0 cyclic prefix portion may be expressed as N_{CP0}. The duration of the CP1 cyclic prefix portion may be expressed as N_{CP1}. As can be seen, the first cyclic prefix portion CP0 has a longer duration than each of the subsequent cyclic prefixes CP1, which have the same duration as one another.

For different values of subcarrier spacing Δf, the figure presents the durations of the OFDM portion (Nᵤ), C0 cyclic prefix (NCP0), C1 cyclic prefix (NCP1), The durations are expressed in terms of number of chips as well as time. As can be seen, a transmitter capable of operating at the different subcarrier spacing values shown would support a range of symbol lengths T_{OFDM}, e.g., 71.35 us, 35.68 us, 17.40 us, 8.92 us, and 4.46 us.

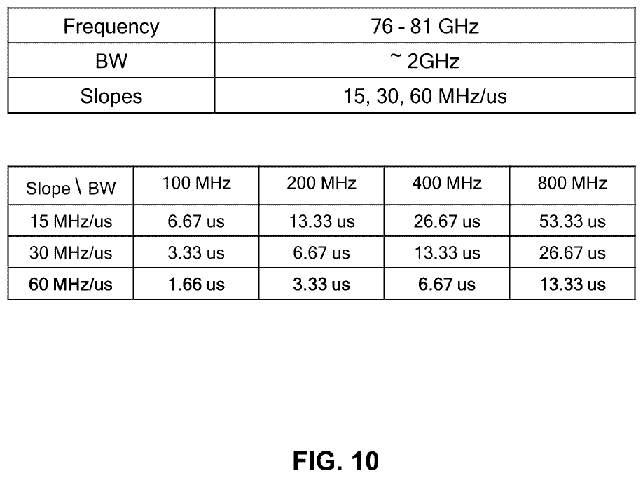

FIG. 10 illustrates an example of the operational capabilities of a commercially available FMCW radar transceiver. This particular FMCW transceiver is capable of operating in the RF frequencies of 76-81 GHz and supports various possible slopes (e.g., 15 MHz/us, 30 MHz/us, and 60 MHz/us) of the linearly increasing FMCW waveform for different possible bandwidths (e.g. 100 MHz, 200 MHZ, 400 MHZ, and 800 MHz). The figure shows the FMCW waveform duration T_{FMCW} for the different combinations of slope and bandwidth. As can be seen, for this particular FMCW radar transceiver, the FMCW waveform duration T_{FMCW} may range from 1.66 us to 53.33 us.

If joint communications and sensing is implemented using the NR OFDM numerology shown in FIG. 9 and the FMCW radar transceiver shown in FIG. 10, different possible scenarios of symbol lengths T_{OFDM} v. FMCW waveform duration T_{FMCW} may emerge. The OFDM symbol length T_{OFDM} ranges from 4.46 us to 71.35 us, and FMCW symbol length T_{FMCW} ranges from 53.33 us to 1.66 us. Thus, the OFDM symbol length T_{OFDM}, in this example, can range from ˜ 1/10 T_{FMCW} to ˜60 T_{FMCW}. In other words, various scenarios can occur, including: T_{FMCW}<T_{OFDM}, T_{FMCW}≈T_{OFDM}, and T_{FMCW}>T_{OFDM}. Some embodiments of the disclosure specifically address the scenario of the FMCW symbol length T_{FMCW} being less than the OFDM symbol length T_{OFDM}.

Furthermore, embodiments of the disclosure implement a unified joint communications and sensing waveform to support a wide variation of uses. The different uses include uplink (UL)-based monostatic, bi-static, and multi-static sensing operations, as well as downlink (DL)-based monostatic, bi-static, and multi-static sensing operations. The different uses also include the re-use of the sending waveform (e.g., FMCW) for communication purposes, such as channel estimation and beam management. The different uses further include different combinations of time-division multiplexing (TDM) and frequency-division multiplexing (FDM) of RF sensing signals (e.g., FMCW) and communications and/or reference signals (e.g., OFDM). Just as an example, a communication device implementing an aspect of the disclosure may comprise a base station, and the FMCW signal and the plurality of OFDM signals may form a downlink transmission from the base station. As another example, a communication device implementing an aspect of the disclosure may comprise a UE, and the FMCW signal and the plurality of OFDM signals may form an uplink transmission from the UE.

In certain embodiments, a time-division multiplexing (TDM) of RF sensing (e.g., FMCW) and OFDM signals is desirable to reduce cost, especially for implementation within a UE. UEs are typically produced in greater numbers of units, compared to the number of base stations produced. Thus, the per-unit cost of UEs is particularly cost sensitive. An analog, wideband FMCW transceiver may be relatively cost effective and well-suited for use in UEs. This is because both the transmitter and receiver of such an analog wideband FMCW transceiver can be built with lower-cost components. On the transmitter side, a voltage-controlled oscillator (VCO) may be used to generate the analog FMCW transmit signal with time-varying frequency (e.g., frequency linearly increasing as a function of time). On the receiver side, the received FMCW signal can be mixed with the transmitted wideband FMCW signal (or a version of the transmitted FMCW signal in the case of bi-static or multi-static sensing) in analog form, before being sampled by a D/A converter. Because the signal being sampled has already been “mixed down,” the sampling rate of the D/A converter can be relatively low. Given that the cost of a D/A converter depends largely on its sampling rate (lower sampling rate corresponding to lower cost), mixing the received signal in analog form allows the cost of the receiver to be significantly lowered. As such, an analog, wideband FMCW transceiver represents a cost-effective option for transmitting and receiving FMCW signals for UEs. However, TDM multiplexing of FMCW and OFDM signals may be spectrally inefficient. A purely TDM implementation means that at any given moment in time, the entire operational frequency bandwidth is devoted to either FMCW or OFDM, such that different bandwidths (e.g., subcarrier bandwidths) cannot be flexibly allocated to FMCW vs. OFDM signals. Such lack of flexibility can lead to inefficient allocation and sharing of the available spectrum between FMCW and OFDM signals.

Aspects of the present disclosure involves resource element (RE)-level frequency-division multiplexing (FDM) between RF sensing signal and OFDM, thereby enhancing the spectrum efficiency of the joint communication and sensing system. Embodiments of the disclosure utilize RE-level FDM between RF sensing and OFDM in a variety of different scenarios. These scenarios may depend on the uplink (UL) vs. downlink (DL) RF sending, monostatic vs. bi-static vs. multi-static sensing, as well as whether the bandwidths of the RF sensing signal (e.g., FMCW) is the same, significantly wider than, and/or overlapping with the bandwidth of the OFDM signal. Examples of these considerations are provided below for illustrative purposes and not intended to be an exhaustive listing of possible scenarios or solutions.

For example, for DL based sensing, on base station side, both the FMCW signal and the OFDM signal can be generated in digital form and converted to analog form for transmission using the same hardware components, e.g., same D/A converter. As another example, in the case of DL bistatic sensing, the UE may have the option to generate a wide bandwidth FMCW signal in the analog domain (e.g., using a VCO-based implementation) to reduce the cost for wideband sensing. In such a scenario, the UE may still implement regular or small bandwidth baseband system for data communications (e.g., OFDM signals). For UL based sensing, if RF sensing and communications are implemented as TDM multiplexed signals, the UE may generate a wideband FMCW transmission signal with a VCO-based implementation. In yet another example, if the RF sensing bandwidth and the communications bandwidth supported by UE are the same or close in magnitude, the UE may implement one set of hardware that is shared between RF sensing and communication. In such a scenario, RE-level FDM multiplexing of the RF sensing signal and OFDM signal may be adopted according to embodiments of the disclosure. However, even in such a scenario, there may still be use cases (SL or UL-based UE-to-UE bistatic sensing) in which UE may still implement an analog FMCW transmitter using a VCO, separately from the OFDM transmitter. Furthermore, comparison between the RF sensing bandwidth and the communication bandwidth may also be taken into account. For example, if the RF sensing bandwidth is much higher than the communication bandwidth, the UE may have two separate hardware chains for RF sensing and communications, according to some embodiments. Here, in the frequency overlap region between the FMCW bandwidth and the OFDM bandwidth, RE-level FDM between the FMCW signal and the OFDM signal can still be implemented, assuming that the two sets of hardware can be calibrated with proper timing alignment.

Thus, according to various embodiments, if the FMCW signal is generated in digital form, a common hardware could be used to generate orthogonal FMCW and the OFDM signal(s) within the same symbol. If the two sets of hardware (e.g., one set of hardware is FFT-based, and the other set of hardware is VCO-based), and the two sets of hardware are calibrated with proper timing alignment, the analog FMCW signal and the OFDM signal(s) can be generated orthogonally (e.g., using different subcarriers). A specification that defines such signals may simply define one or a group of unified digital FMCW waveforms that are compatible with a cyclic prefix CP-OFDM framework and supports FDM multiplexing of the FMCW and OFDM signals. The exact implementation of the chirp waveform on UE side may depend on the applicable use case(s)/scenario(s).

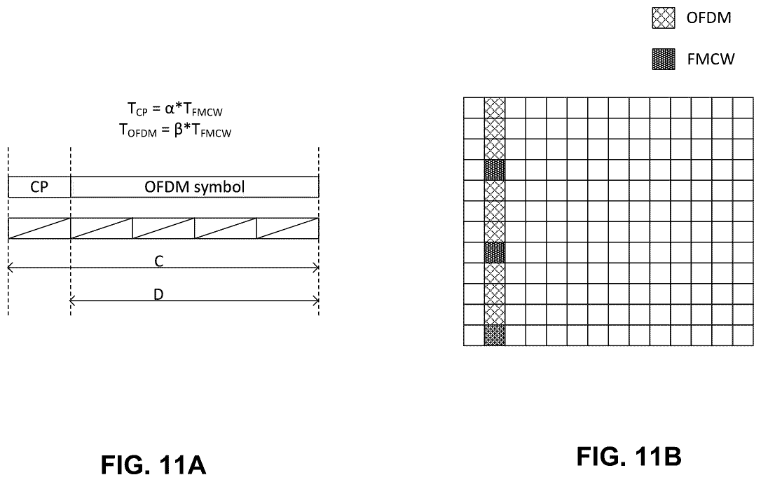

FIGS. 11A and 11B present an example of a unified joint communications and sensing waveform design for resource element (RE)-level frequency-division multiplexing of FMCW and OFDM signals incorporating an integer-duration cyclic prefix, according to some embodiments of the disclosure. In various embodiments, signals for communication and sensing are transmitted. The technique involves transmitting, from a communication device, a frequency modulated continuous wave (FMCW) signal within an air interface frame structure having a plurality of resource elements, each resource element defined over a symbol duration in a time domain and a subcarrier in a frequency domain. The technique further involves transmitting, from the communication device, a plurality of orthogonal frequency-division multiplexing (OFDM) signals within the air interface frame structure. The FMCW signal may occupy a first plurality of resource elements in the air interface frame structure and comprise a FMCW waveform repeated in the time domain and transmitted during a first symbol, over a first plurality of subcarriers of the air interface frame structure. The plurality of OFDM signals may occupy a second plurality of resource elements in the air interface frame structure and are transmitted during the first symbol, over a second plurality of subcarriers of the air interface frame structure. In this context, a “communication device” broadly refers to any device configured to transmit and/or receive signals for communicating data and includes, for example, base stations, user equipment, etc.

FIG. 11A presents a time-domain representation of an example of such a unified joint communications and sensing waveform design incorporating an integer-duration cyclic prefix. Here, the numerology of the FMCW signal follows a set of defined durational relationships:

$${T}_{C P} = α * {T}_{F M C W} \qquad ( Eq . 5 )$$

$${T}_{O F D M} = β * {T}_{F M C W} \qquad ( Eq . 6 )$$

where α and β are positive integers, and α<β. In the example shown in the figure, α=1 and β=5. Thus, in this example, the cyclic prefix symbol duration T_{CP} is equal to 1*T_{FMCW}. In this example, the OFDM symbol duration T_{OFDM} (including the cyclic prefix) is equal to 5*T_{FMCW}. As can be seen, the FMCW waveform is repeated over the OFDM symbol duration, following the relationships defined in Eqs. 5 and 6. FIG. 11B presents a frequency-domain representation of the same unified joint communications and sensing waveform design incorporating an integer-duration cyclic prefix. According to embodiments of the disclosure, the repetition of the FMCW waveform in the time domain results in a “comb” structure by which the FMCW waveform is repeated over evenly spaced subcarriers in the frequency domain. In some embodiments, such as that shown in the figure, the FMCW waveforms is repeated α times over the cyclic preamble (CP) portion of the symbol, α being a positive integer. The FMCW waveform is repeated (β−α) times over an OFDM portion of the first symbol, β being a positive integer greater than α. The first plurality of resource elements occupied by the FMCW signal comprise 1 out of every (β−α) resource elements over the first symbol in a resource block of the air interface frame structure. The second plurality of resource elements occupied by the OFDM signal comprise ((β−α)−1) out of every (β−α) resource elements over the first symbol in the resource block of the air interface frame structure. In the particular example shown, α=1 and β=5. Thus, in this example, the first plurality of resource elements occupied by the FMCW signal comprise 1 out of every (5−1)=4 resource elements over the first symbol in the resource block. The second plurality of resource elements occupied by the OFDM signal comprises ((5−1)−1)=3 out of every (5−1)=4 resource elements over the first symbol in the resource block. Here, the resource block spans 14 symbols and 12 subcarriers. While joint communication and sensing using resource element-level frequency-division multiplexing across sub-carriers is illustrated for just one symbol, a similar approach can be implemented over one or more other symbols of the resource block.

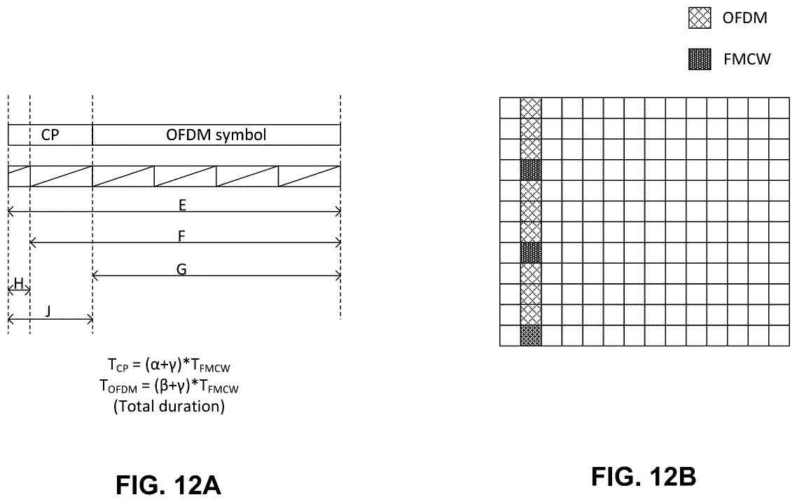

FIGS. 12A and 12B present an example of a unified joint communications and sensing waveform design for RE-level frequency-division multiplexing of FMCW and OFDM signals incorporating a fractional-duration cyclic prefix, according to some embodiments of the disclosure. FIG. 12A presents a time-domain representation of an example of such a unified joint communications and sensing waveform design. Again, the numerology of the FMCW signal follows a set of defined durational relationships:

$${T}_{C P} = ( α + γ ) * {T}_{F M C W} \qquad ( Eq . 7 )$$

$${T}_{O F D M} = ( β + γ ) * {T}_{F M C W} \qquad ( Eq . 8 )$$

where α and β are positive integers, α<β., and γ is a positive fraction less than 1. In the example shown in the figure, α=1. β=5, and γ=⅓. Thus, in this example, the cyclic prefix symbol duration T_{CP} is equal to (1+⅓)*T_{FMCW}. In this example, the OFDM symbol duration T_{OFDM} (including the cyclic prefix) is equal to (5+⅓)*T_{FMCW}. As can be seen, the FMCW waveform is repeated over the OFDM symbol duration, following the relationships defined in Eqs. 7 and 8. FIG. 12B presents a frequency-domain representation of the same unified joint communications and sensing waveform design incorporating a fractional-duration cyclic prefix. Again, according to embodiments of the disclosure, the repetition of the FMCW waveform in the time domain results in a “comb” structure by which the FMCW waveform is repeated over evenly spaced subcarriers in the frequency domain. In some embodiments, such as that shown in the figure, the FMCW waveforms is repeated (α+γ) times over the cyclic preamble (CP) portion of the symbol, α being a positive integer, and γ being a fractional value less than 1. The FMCW waveform is repeated (β−α) times over an OFDM portion of the first symbol, β being a positive integer greater than α. The first plurality of resource elements occupied by the FMCW signal comprise 1 out of every (β−α) resource elements over the first symbol in a resource block of the air interface frame structure. The second plurality of resource elements occupied by the OFDM signal comprise ((β−α)−1) out of every (β−α) resource elements over the first symbol in the resource block of the air interface frame structure. In the particular example shown, α=1 and β=5. Thus, in this example, the first plurality of resource elements occupied by the FMCW signal comprise 1 out of every (5−1)=4 resource elements over the first symbol in the resource block. The second plurality of resource elements occupied by the OFDM signal comprises ((5−1)−1)=3 out of every (5−1)=4 resource elements over the first symbol in the resource block. Here, the resource block spans 14 symbols and 12 subcarriers. Once again, while joint communication and sensing using resource element-level frequency-division multiplexing across sub-carriers is illustrated for just one symbol, a similar approach can be implemented over one or more other symbols of the resource block.

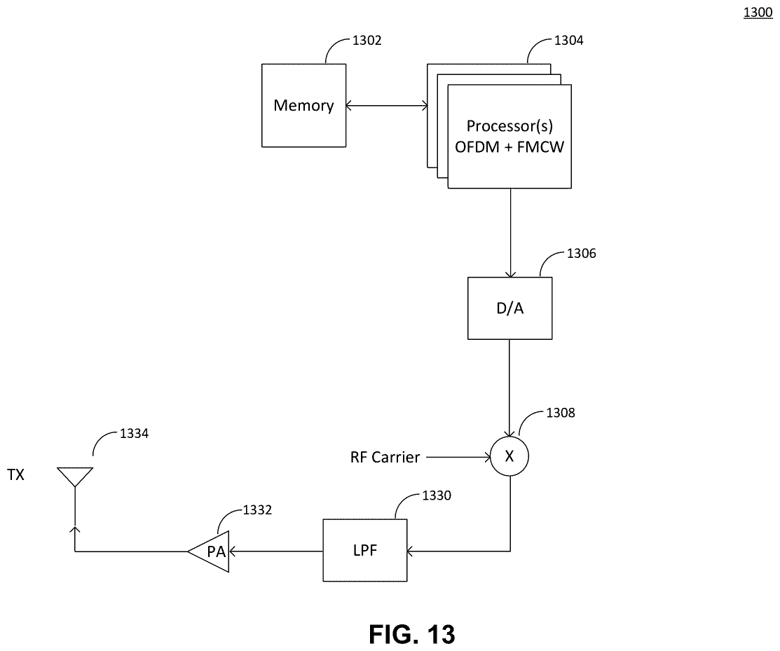

FIGS. 13-16 illustrate various configurations for transmitting or receiving resource element (RE)-level frequency-division multiplexed (FDM) joint communication and sensing (JCS) signals, according to different embodiments of the disclosure. From a transmitter perspective, an FMCW could be implemented digitally or as an analog signal. In a scenario where the same or similar bandwidth is used for RF sensing and communications, some embodiments of the disclosure may utilize one set of hardware for generating both FMCW signals and OFDM signals. In a scenario where the RF sensing bandwidth is much larger than communications bandwidth, the UE may utilize a separate set of hardware (e.g., VCO-based analog device) for generating the FMCW signal. In such cases, where two sets of HW are used, timing alignment is implemented between the analog FMCW signal generation and the digital OFDM signal generation, according to some embodiments of the disclosure. For example, a UE may be implemented to be capable of calibrating the two sets of hardware to achieve satisfactory timing alignment between the analog FMCW signal and the digital OFDM signal.

From a receiver perspective, a UE may implement an FMCW receiver utilizing a VCO-based implementation, in order to reduce the sampling rate/bandwidth requirements placed on the A/D converter and thereby reducing cost (as discussed in previous sections). Such a VCO-based, analog FMCW receiver implementation may be used, for example, for FR2/FR3/THz downlink bistatic RF sensing with a large RF sensing signal BW, to achieve significant cost savings at the UE side. In such an implementation, the UE may have two separate hardware chains for receiving and processing of OFDM and FMCW signals.

FIG. 13 presents a portion 1300 of a communication device implementing transmission of RE-level FDM multiplexed JCS signals using a single set of hardware for generating both FMCW and OFDM signals, according to some embodiments of the disclosure.

Portion 1300 represents an example of a device for transmitting signals for communication and sensing comprising a memory, one or more processors coupled to the memory, a digital-to-analog (D/A) converter coupled to the one or more processors, and one or more antennas coupled to the D/A converter. The one or more processors are configured to generate a digital signal comprising (1) a frequency modulated continuous wave (FMCW) signal within an air interface frame structure having a plurality of resource elements, each resource element defined over a symbol duration in a time domain and a subcarrier in a frequency domain, and (2) a plurality of orthogonal frequency-division multiplexing (OFDM) signals within the air interface frame structure. The FMCW signal occupies a first plurality of resource elements in the air interface frame structure and comprises a FMCW waveform repeated in the time domain and transmitted during a first symbol, over a first plurality of subcarriers of the air interface frame structure. The plurality of OFDM signals occupy a second plurality of resource elements in the air interface frame structure and is transmitted during the first symbol, over a second plurality of subcarriers of the air interface frame structure. The D/A converter is configured generate an analog signal based on the digital signal. The one or more antennas are configured to transmit a radio frequency (RF) signal based on the analog signal.

The components shown in FIG. 13 are merely illustrative, and alternative implementations may include different components arranged in various ways to achieve the same or similar functionality. As shown, portion 1300 includes a memory 1302, one or more processors 1304, a D/A converter 1306, a mixer 1308, a low-pass filter 1330, a power amplifier 1332, and one or more antennas 1336. The one or more processors 1304 obtain data symbols from higher-level protocols and modulate the data symbols as OFDM symbols onto one set of sub-carriers in a symbol duration. The one or more processors 1304 also generate a FMCW signal comprising a repetition of a FMCW waveform an integer or fractional number of times during the same symbol duration, to produce a comb structure comprising the FMCW signal occupying another set of sub-carriers. The one or more processors 1304 thus generates, in digital form, a RE-level FDM multiplexed JCS signal. The D/A converter 1306 receives the digital RE-level FDM multiplexed JCS signal and converts it to an analog signal. The mixer 1308 mixes the analog signal from an intermediate frequency (IF) to a radio frequency (RF). The low-pass filter 30 filters the analog RF signal. The power amplifier 1332 amplifies the filtered, analog RF signal. The one or more antennas 1334 then transmit the power amplified signal.

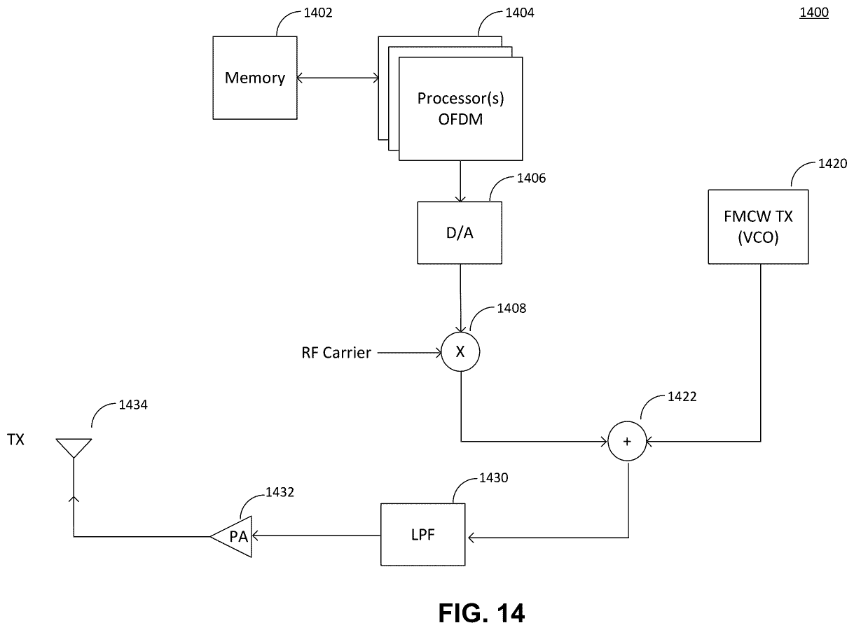

FIG. 14 presents a portion 1400 of a communication device implementing transmission of RE-level FDM multiplexed JCS signals using one set of hardware for generating FMCW signals and another set of hardware for generating OFDM signals, according to some embodiments of the disclosure.

Portion 1400 represents an example of a device for transmitting signals for communication and sensing comprising a memory, one or more processors coupled to the memory, a digital-to-analog (D/A) converter coupled to the one or more processors, a frequency modulated continuous wave (FMCW) signal generator, a combiner coupled to the D/A converter and the FMCW signal generator, and one or more antennas coupled to the combiner. The FMCW signal generator is configured to generate, as a first analog signal, a FMCW signal within an air interface frame structure having a plurality of resource elements, each resource element defined over a symbol duration in a time domain and a subcarrier in a frequency domain, the FMCW signal occupying a first plurality of resource elements in the air interface frame structure and comprising a FMCW waveform repeated in the time domain and transmitted during a first symbol, over a first plurality of subcarriers of the air interface frame structure. The one or more processors are configured to generate, as a digital signal, a plurality of orthogonal frequency-division multiplexing (OFDM) signals within the air interface frame structure, the plurality of OFDM signals occupying a second plurality of resource elements in the air interface frame structure and is transmitted during the first symbol, over a second plurality of subcarriers of the air interface frame structure. The D/A converter is configured to generate a second analog signal based on the digital signal. The combiner is configured to generate a combined analog signal based on first analog signal and the second analog signal. The one or more antennas are configured to transmit a radio frequency (RF) signal based on the combined analog signal.

The components shown in FIG. 14 are merely illustrative, and alternative implementations may include different components arranged in various ways to achieve the same or similar functionality. As shown, portion 1400 includes a memory 1402, one or more processors 1404, a D/A converter 1406, a mixer 1408, a FMCW signal generator 1420, a combiner 1422, a low-pass filter 1430, a power amplifier 1432, and one or more antennas 1434. The one or more processors 1404 obtain data symbols from higher-level protocols and modulate the data symbols as OFDM symbols onto one set of sub-carriers in a symbol duration, to generate a digital OFDM signal. The one or more processors 1404 may perform operations described herein by carrying out executable instructions stored in the memory 1402. The D/A converter 1406 converts the digital OFDM signal into an analog OFDM signal. The mixer 1408 converts the analog OFDM signal from an intermediate frequency (IF) to a radio frequency (RF). Separately, an FMCW signal generator 1420 generates an analog FMCW signal comprising a repetition of a FMCW waveform an integer or fractional number of times during the same symbol duration, to produce a comb structure comprising the FMCW signal occupying another set of sub-carriers. The FMCW signal generator 1420 may be implemented using, e.g., a VCO, to generate the analog FMCW transmit signal with time-varying frequency. The combiner 1422 combines the analog OFDM signal with the analog FMCW transmit signal to produce a RE-level FDM multiplexed JCS signal. According to aspects of the disclosure, the one or more processors 1404 and the FMCW signal generator 1420 are synchronized to facilitate time-aligning the analog OFDM signal and the analog FMCW transmit signal prior to combining the two analog signals. The low-pass filter 1430 filters the RE-level FDM multiplexed JCS signal. The power amplifier 1332 amplifies the filtered signal. The one or more antennas 1334 then transmit the power amplified signal.

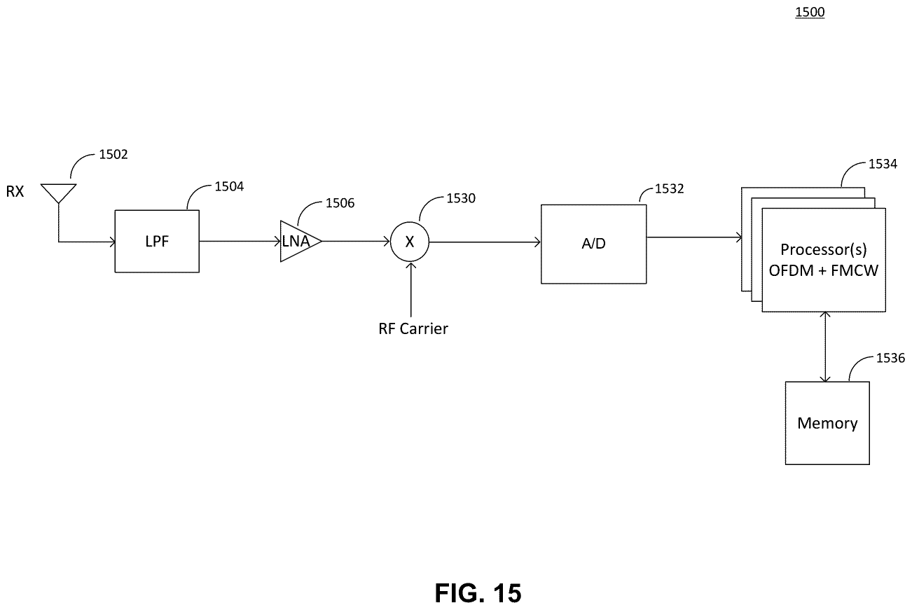

FIG. 15 presents a portion 1500 of a communication device implementing reception of RE-level FDM multiplexed JCS signals using a single set of hardware for processing of both received FMCW and received OFDM signals, according to some embodiments of the disclosure.

Portion 1500 represents an example of a device for receiving signals for communication and sensing comprising one or more antennas, an analog-to-digital (A/D) converter coupled to the one or more antennas, one or more processors coupled to the A/D converter, and a memory coupled to the one or more processors. The one or more antennas are configured to receive a radio frequency (RF) signal, the RF signal comprising (1) a frequency modulated continuous wave (FMCW) signal within an air interface frame structure having a plurality of resource elements, each resource element defined over a symbol duration in a time domain and a subcarrier in a frequency domain, and (2) a plurality of orthogonal frequency-division multiplexing (OFDM) signals within the air interface frame structure. The FMCW signal occupies a first plurality of resource elements in the air interface frame structure and comprises a FMCW waveform repeated in the time domain and transmitted during a first symbol, over a first plurality of subcarriers of the air interface frame structure. The plurality of OFDM signals occupy a second plurality of resource elements in the air interface frame structure and is transmitted during the first symbol, over a second plurality of subcarriers of the air interface frame structure. The A/D converter is configured to generate a digital signal based on the RF signal. The one or more processors are configured receive the digital signal and (1) generate one or more of a range estimate, a Doppler estimate, and/or an Angle of Arrival (AoA) estimate based on the FMCW signal as represented in the digital signal and (2) generate demodulated data symbols based on the plurality of OFDM signals as represented in the digital signal.

The components shown in FIG. 15 are merely illustrative, and alternative implementations may include different components arranged in various ways to achieve the same or similar functionality. As shown, portion 1500 includes one or more antennas 1502, a low pass filter (LPF) 1504, a low noise amplifier (LNA) 1506, a mixer 1530, an A/D converter 1532, one or more processors 1534, and a memory 1536. The one or more antennas 1502 receive a RE-level FDM multiplexed JCS signal comprising a plurality of OFDM signals and a FMCW signal. The OFDM signals comprise data symbols modulated onto one set of sub-carriers in a symbol duration. The FMCW signal comprises a repetition of a FMCW waveform an integer or fractional number of times during the same symbol duration, corresponding to a comb structure comprising the FMCW signal occupying another set of sub-carriers. The low-pass filter 1504 filters the received signal. The LNA 1506 amplifies the filtered signal. The mixer 1530 down-converts the amplified, filtered signal from an RF frequency to an IF frequency. The A/D converter 1532 converts the IF signal from analog to digital form. The one or more processors 1534 receives and processes the digital IF JCS signal. Here, the one or more processors 1534 performs both (1) demodulation of the OFDM data symbols from the OFDM portion of the digital IF JCS signal, to generate received data symbols and (2) processing of the FMCW portion of the digital IF JCS signal to generate range, Doppler, and/or AoA estimates. Processing of the FMCW portion of the signal may be similar to that shown in FIG. 5, but with operations including mixing (e.g., mixer 508) and filtering (e.g., LPF 510) performed in digital form, without use of a VCO. The one or more processors 1534 may perform such operations by carrying out executable instructions stored in the memory 1536.

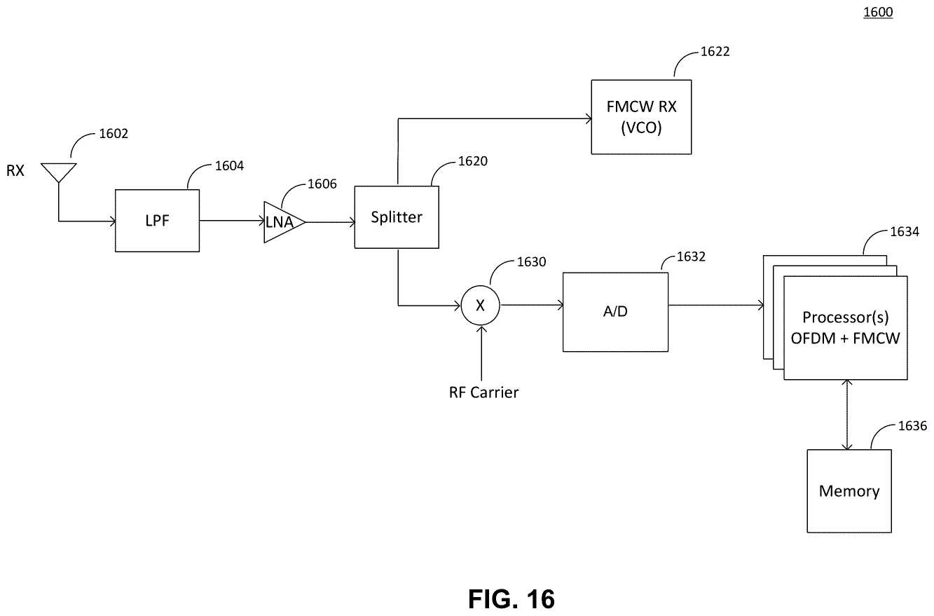

FIG. 16 presents a portion 1600 of a communication device implementing reception of RE-level FDM multiplexed JCS signals using one set of hardware for processing of received FMCW signals and another set of hardware for processing of received OFDM signals, according to some embodiments of the disclosure.

Portion 1600 represents an example of a device for receiving signals for communication and sensing comprising one or more antennas a signal splitter, a frequency modulated continuous wave (FMCW) receiver coupled to the signal splitter, an analog-to-digital (A/D) converter coupled to the signal splitter, one or more processors coupled to the A/D converter, a memory coupled to the one or more processors. The one or more antennas are configured to receive a radio frequency (RF) signal, the RF signal comprising (1) a frequency modulated continuous wave (FMCW) signal within an air interface frame structure having a plurality of resource elements, each resource element defined over a symbol duration in a time domain and a subcarrier in a frequency domain, and (2) a plurality of orthogonal frequency-division multiplexing (OFDM) signals within the air interface frame structure. The FMCW signal occupies a first plurality of resource elements in the air interface frame structure and comprises a FMCW waveform repeated in the time domain and transmitted during a first symbol, over a first plurality of subcarriers of the air interface frame structure. The plurality of OFDM signals occupy a second plurality of resource elements in the air interface frame structure and is transmitted during the first symbol, over a second plurality of subcarriers of the air interface frame structure. The splitter is configured to generate a first split signal and a second split signal based on the RF signal. The FMCW receiver is configured to generate one or more of a range estimate, a Doppler estimate, and/or an Angle of Arrival (AoA) estimate based on the FMCW signal as represented in the first split signal. The A/D converter is configured to generate a digital signal based on the second split signal. The one or more processors are configured to generate demodulated data symbols based on the digital signal.

The components shown in FIG. 16 are merely illustrative, and alternative implementations may include different components arranged in various ways to achieve the same or similar functionality. As shown, portion 1600 includes one or more antennas 1602, a low pass filter (LPF) 1604, a low noise amplifier (LNA) 1606, a splitter 1620, an FMCW receiver 1622, a mixer 1630, an A/D converter 1632, one or more processors 1634, and a memory 1636. The one or more antennas 1602 receive a RE-level FDM multiplexed JCS signal comprising a plurality of FMCW signals and an OFDM signal as described previously. The low pass filter 1604 filters the received signal. The LNA 1606 amplifies the filtered signal. The splitter 1620 splits the filtered and amplified JCS signal into a first split signal and a second split signal. The FMCW receiver 1622 receives the first split signal and processes the FMCW signal contain therein and generate one or more of a range estimate, a Doppler estimate, or an AoA estimate. The FMCW receiver 1622 may be implemented using a VCO to generate a version of the analog FMCW transmit signal with time-varying frequency, as well as a D/A converter with a relatively low sampling rate. The mixer 1630 down converts the second split signal from an RF frequency to an IF frequency. The A/D converter 1632 converts the IF signal from analog to digital form. The one or more processors 1634 demodulates the OFDM portion of the digital IF JCS signal, to generate received data symbols. The one or more processors 1634 may perform such operations by carrying out executable instructions stored in the memory 1636.

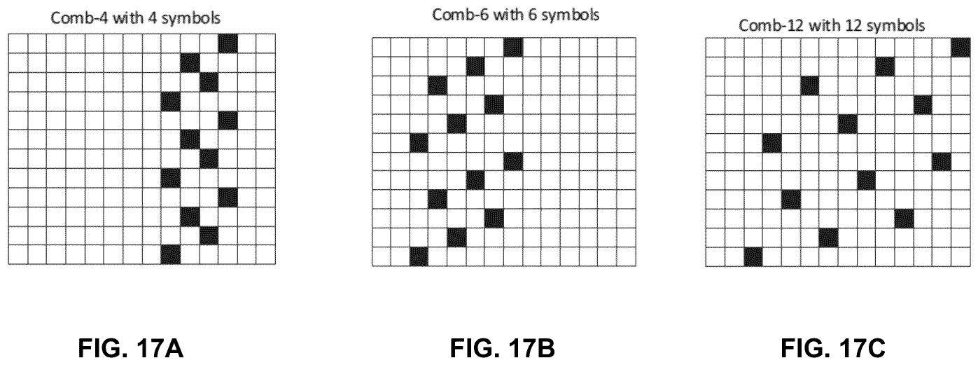

FIG. 17A-17C illustrate the use of existing position reference signal (PRS) comb patterns for the transmission of FMCW signals for multi-device sensing, according to some embodiments of the disclosure. Here, “multi-device” sensing refers to sensing performed using multiple devices as transmitters of RF sensing signals (e.g., FMCW signals). Thus, multi-device sensing can involve multiple TRPs transmitting RF sensing (multi-TRP sensing) and/or multiple UE transmitting RF sensing signals (multi-UE sensing). For some use cases, multi-device sensing is appropriate. One such use case is target localization, by which the location of a target is determined based on RF sensing performed by multiple TRPs (e.g., base stations) and/or UEs. According to embodiments of the disclosure, such multiple TRPs and/or UEs may share a same group of symbols for comb-based FMCW transmission. Each TRP or UE is allocated a different comb offset to transmit its FMCW signal within the comb pattern. The use of a comb-based design for FMCW transmissions may be particularly effective in mitigating, e.g., the near-fart effect among multiple TRPs. Generally speaking, a comb-N pattern spanning L symbols within the air interface frame structure may be used, L and N being positive, non-zero integers. The comb-N pattern is occupied by OFDM signals and FMCW signals transmitted from a plurality of communication devices, such as a number, L, of TRPs and/or UEs. In some embodiments, the FMCW transmission from each of the plurality of communication devices occupies a different frequency offset portion of the comb-N pattern. In each of FIGS. 17A-17C, the comb-N pattern comprises an existing PRS comb-based pattern defined according the 3GPP Release 16 standard. FIG. 17A presents a comb-4 pattern defined over a group of 4 symbols (N=4, L=4). FIG. 17B presents a comb-6 pattern defined over a group of 6 symbols (N=6, L=6). FIG. 17C presents a comb-12 pattern defined over a group of 12 symbols (N=12, L=12).

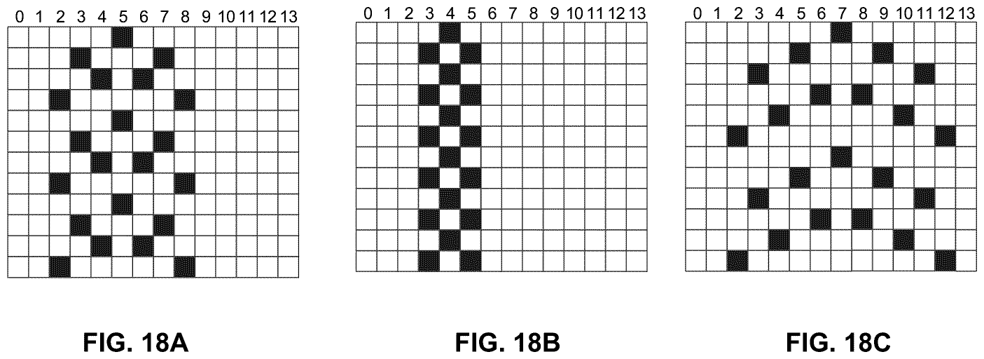

FIGS. 18A-18C illustrate the use of new, symmetric comb patterns for the transmission of FMCW signals used for multi-device sensing. As discussed, multi-device sensing may be appropriate in certain use cases, e.g., target localization. Here, multiple TRPs (e.g., base stations) and/or UEs may perform RF sensing in a coordinated manner, by sharing a same group of symbols for comb-based FMCW transmission. Each TRP or UE is allocated a different comb offset to transmit its FMCW signal within the comb pattern. Again, a comb-N pattern spanning L symbols within the air interface frame structure may be used. In each of FIGS. 18A-18C, the comb-N pattern comprises a symmetrical structure, e.g., a new, symmetrical comb-based pattern having center symbol and one or more pairs of symmetric symbols. Each pair of symmetric symbols utilize the same comb offset. FIG. 17A presents a comb-4 pattern defined over a group of 7 symbols (N=4, L=7), with symbol 5 as the center symbol, symbols 4 and 6 as a first pair of symmetric symbols, symbols 3 and 7 as a second pair of symmetric symbols, and symbols 2 and 8 as a third pair of symmetric symbols. FIG. 17B presents a comb-2 pattern defined over a group of 3 symbols (N=2, L=3), with symbol 4 as the center symbol, and symbols 3 and 5 as a pair of symmetric symbols. FIG. 17C presents a comb-6 pattern defined over a group of 11 symbols (N=6, L=11), with symbol 7 as the center symbol, symbols 6 and 8 as a first pair of symmetric symbols, symbols 5 and 9 as a second pair of symmetric symbols, symbols 4 and 10 as a third pair of symmetric symbols, symbols 3 and 11 as a fourth pair of symmetric symbols, and symbols 2 and 12 as a fifth pair of symmetric symbols.

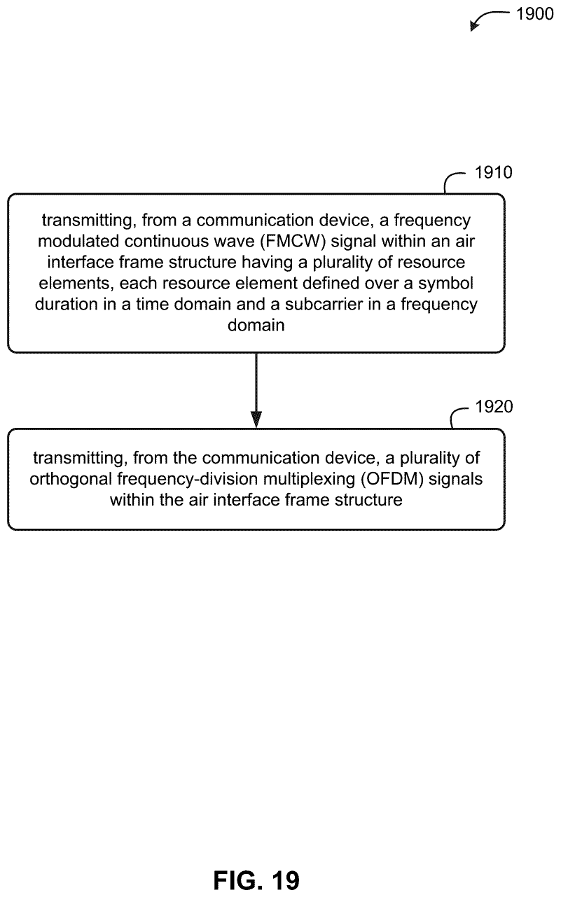

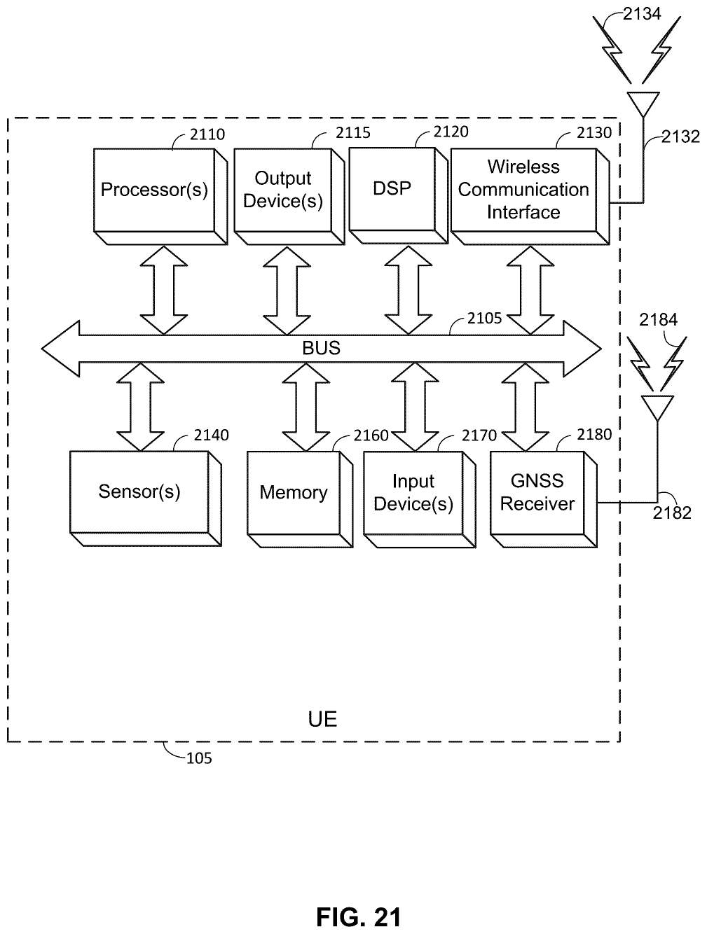

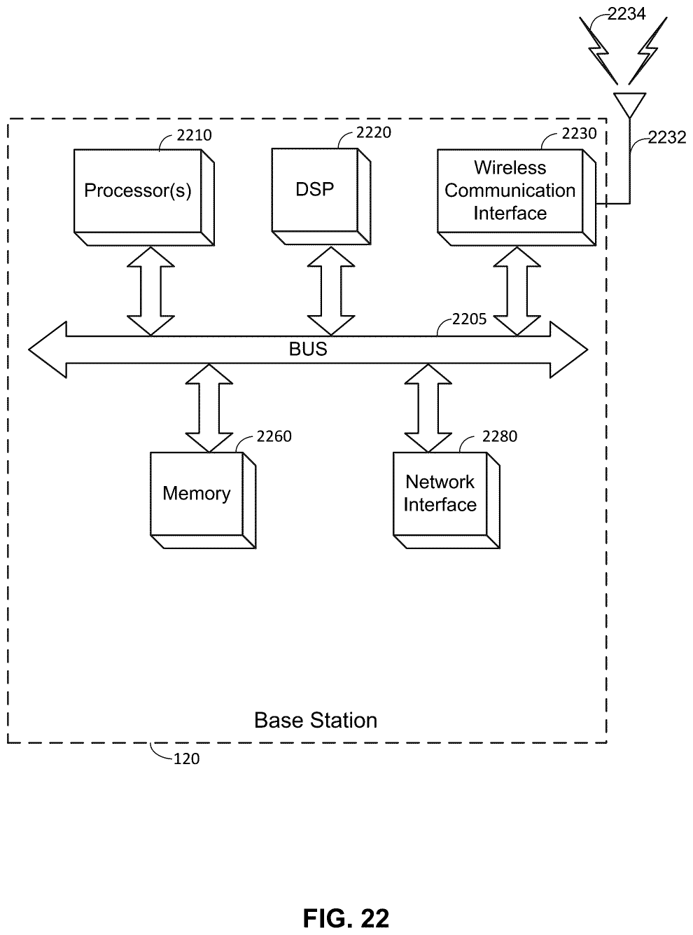

FIG. 19 is a flow diagram of a method 1900 of transmitting signals for communication and sensing, according to an embodiment. Means for performing the functionality illustrated in one or more of the blocks shown in FIG. 19 may be performed by hardware and/or software components of, for example, a UE and/or a base station. Example components of a UE and a base station are illustrated FIGS. 21 and 22, which are described in more detail in later sections.

At block 1910, the functionality comprises transmitting, from a communication device, a frequency modulated continuous wave (FMCW) signal within an air interface frame structure having a plurality of resource elements, each resource element defined over a symbol duration in a time domain and a subcarrier in a frequency domain. Means for performing the functionality at block 1210 may comprise a memory, one or more processors, a D/A converter, a mixer, an FMCW signal generator, a combiner, a low-pass filter, a power amplifier, one or more antennas, and/or other components of a UE or a base station, as illustrated in FIGS. 13 and/or 14.

At block 1920, the functionality comprises transmitting, from the communication device, a plurality of orthogonal frequency-division multiplexing (OFDM) signals within the air interface frame structure. Means for performing the functionality at block 1220 may comprise a memory, one or more processors, a D/A converter, a mixer, a combiner, a low-pass filter, a power amplifier, one or more antennas, and/or other components of a UE or a base station, as illustrated in FIGS. 13 and/or 14.

The FMCW signal may occupy a first plurality of resource elements in the air interface frame structure and comprise a FMCW waveform repeated in the time domain and transmitted during a first symbol, over a first plurality of subcarriers of the air interface frame structure. The plurality of OFDM signals may occupy a second plurality of resource elements in the air interface frame structure and are transmitted during the first symbol, over a second plurality of subcarriers of the air interface frame structure.

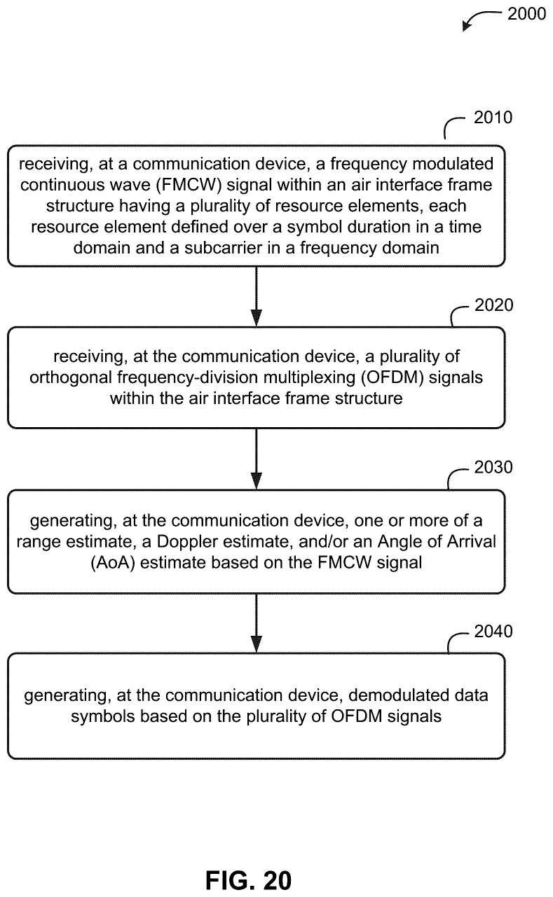

FIG. 20 is a flow diagram of a method of receiving signals for communication and sensing, according to an embodiment. Means for performing the functionality illustrated in one or more of the blocks shown in FIG. 20 may be performed by hardware and/or software components of, for example, a UE and/or a base station. Example components of a UE and a base station are illustrated FIGS. 21 and 22, which are described in more detail in later sections.

At block 2010, the functionality comprises receiving, at a communication device, a frequency modulated continuous wave (FMCW) signal within an air interface frame structure having a plurality of resource elements, each resource element defined over a symbol duration in a time domain and a subcarrier in a frequency domain. Means for performing the functionality at block 2010 may comprise one or more antennas, a low-pass filter, a low noise amplifier, a mixer, a splitter, an FMCW receiver, an A/D converter, one or more processors, a memory, and/or other components of a UE or a base station, as illustrated in FIGS. 15 and/or 16.

At block 2020, the functionality comprises receiving, at the communication device, a plurality of orthogonal frequency-division multiplexing (OFDM) signals within the air interface frame structure. Means for performing the functionality at block 2020 may comprise one or more antennas, a low-pass filter, a low noise amplifier, a mixer, a splitter, an A/D converter, one or more processors, a memory, and/or other components of a UE or a base station, as illustrated in FIGS. 15 and/or 16.

At block 2030, the functionality comprises generating, at the communication device, one or more of a range estimate, a Doppler estimate, and/or an Angle of Arrival (AoA) estimate based on the FMCW signal. Means for performing the functionality at block 2030 may comprise an FMCW receiver, one or more processors, a memory, and/or other components of a UE or a base station, as illustrated in FIGS. 15 and/or 16.

At block 2040, the functionality comprises generating, at the communication device, demodulated data symbols based on the plurality of OFDM signals. Means for performing the functionality at block 2040 may comprise one or more processors, a memory, and/or other components of a UE or a base station, as illustrated in FIGS. 15 and/or 16.

The FMCW signal may occupy a first plurality of resource elements in the air interface frame structure and comprise a FMCW waveform repeated in the time domain and transmitted during a first symbol, over a first plurality of subcarriers of the air interface frame structure. The plurality of OFDM signals may occupy a second plurality of resource elements in the air interface frame structure and are transmitted during the first symbol, over a second plurality of subcarriers of the air interface frame structure

FIG. 21 is a block diagram of an embodiment of a UE 105, which can be utilized as described herein above (e.g., in association with FIGS. 5, 13, 14, 15, and/or 16). For example, the UE 105 can perform one or more of the functions of the method shown in FIGS. 19 and/or 20. It should be noted that FIG. 21 is meant only to provide a generalized illustration of various components, any or all of which may be utilized as appropriate. It can be noted that, in some instances, components illustrated by FIG. 21 can be localized to a single physical device and/or distributed among various networked devices, which may be disposed at different physical locations. Furthermore, as previously noted, the functionality of the UE discussed in the previously described embodiments may be executed by one or more of the hardware and/or software components illustrated in FIG. 21.

The UE 105 is shown comprising hardware elements that can be electrically coupled via a bus 2105 (or may otherwise be in communication, as appropriate). The hardware elements may include a processor(s) 2110 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 2110 may comprise one or more processing units, which may be housed in a single integrated circuit (IC) or multiple ICs. As shown in FIG. 21, some embodiments may have a separate DSP 2120, depending on desired functionality. Location determination and/or other determinations based on wireless communication may be provided in the processor(s) 2110 and/or wireless communication interface 2130 (discussed below). The UE 105 also can include one or more input devices 2170, which can include without limitation one or more keyboards, touch screens, touch pads, microphones, buttons, dials, switches, and/or the like; and one or more output devices 2115, which can include without limitation one or more displays (e.g., touch screens), light emitting diodes (LEDs), speakers, and/or the like.

The UE 105 may also include a wireless communication interface 2130, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the UE 105 to communicate with other devices as described in the embodiments above. The wireless communication interface 2130 may permit data and signaling to be communicated (e.g., transmitted and received) with TRPs of a network, for example, via eNBs, gNBs, ng-eNBs, access points, various base stations and/or other access node types, and/or other network components, computer systems, and/or any other electronic devices communicatively coupled with TRPs, as described herein. The communication can be carried out via one or more wireless communication antenna(s) 2132 that send and/or receive wireless signals 2134. According to some embodiments, the wireless communication antenna(s) 2132 may comprise a plurality of discrete antennas, antenna arrays, or any combination thereof. The antenna(s) 2132 may be capable of transmitting and receiving wireless signals using beams (e.g., Tx beams and Rx beams). Beam formation may be performed using digital and/or analog beam formation techniques, with respective digital and/or analog circuitry. The wireless communication interface 2130 may include such circuitry.

Depending on desired functionality, the wireless communication interface 2130 may comprise a separate receiver and transmitter, or any combination of transceivers, transmitters, and/or receivers to communicate with base stations (e.g., ng-eNBs and gNBs) and other terrestrial transceivers, such as wireless devices and access points. The UE 105 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The UE 105 can further include sensor(s) 2140. Sensor(s) 2140 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the UE 105 may also include a Global Navigation Satellite System (GNSS) receiver 2180 capable of receiving signals 2184 from one or more GNSS satellites using an antenna 2182 (which could be the same as antenna 2132). Positioning based on GNSS signal measurement can be utilized to complement and/or incorporate the techniques described herein. The GNSS receiver 2180 can extract a position of the UE 105, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 2180 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 2180 is illustrated in FIG. 21 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 2110, DSP 2120, and/or a processor within the wireless communication interface 2130 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), particle filter, or the like. The positioning engine may also be executed by one or more processors, such as processor(s) 2110 or DSP 2120.

The UE 105 may further include and/or be in communication with a memory 2160. The memory 2160 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 2160 of the UE 105 also can comprise software elements (not shown in FIG. 21), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 2160 that are executable by the UE 105 (and/or processor(s) 2110 or DSP 2120 within UE 105). In some embodiments, then, such code and/or instructions can be used to configure and/or adapt a general-purpose computer (or other device) to perform one or more operations in accordance with the described methods.

FIG. 22 is a block diagram of an embodiment of a base station 120, which can be utilized as described herein above (e.g., in association with FIGS. 5, 13, 14, 15, and/or 16). For example, the UE 105 can perform one or more of the functions of the method shown in FIGS. 19 and/or 20. It should be noted that FIG. 22 is meant only to provide a generalized illustration of various components, any or all of which may be utilized as appropriate. In some embodiments, the base station 120 may correspond to a gNB, an ng-eNB, and/or (more generally) a TRP.

The base station 120 is shown comprising hardware elements that can be electrically coupled via a bus 2205 (or may otherwise be in communication, as appropriate). The hardware elements may include a processor(s) 2210 which can include without limitation one or more general-purpose processors, one or more special-purpose processors (such as DSP chips, graphics acceleration processors, ASICs, and/or the like), and/or other processing structure or means. As shown in FIG. 22, some embodiments may have a separate DSP 2220, depending on desired functionality. Location determination and/or other determinations based on wireless communication may be provided in the processor(s) 2210 and/or wireless communication interface 2230 (discussed below), according to some embodiments. The base station 120 also can include one or more input devices, which can include without limitation a keyboard, display, mouse, microphone, button(s), dial(s), switch(es), and/or the like; and one or more output devices, which can include without limitation a display, light emitting diode (LED), speakers, and/or the like.

The base station 120 might also include a wireless communication interface 2230, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, cellular communication facilities, etc.), and/or the like, which may enable the base station 120 to communicate as described herein. The wireless communication interface 2230 may permit data and signaling to be communicated (e.g., transmitted and received) to UEs, other base stations/TRPs (e.g., eNBs, gNBs, and ng-eNBs), and/or other network components, computer systems, and/or any other electronic devices described herein. The communication can be carried out via one or more wireless communication antenna(s) 2232 that send and/or receive wireless signals 2234.

The base station 120 may also include a network interface 2280, which can include support of wireline communication technologies. The network interface 2280 may include a modem, network card, chipset, and/or the like. The network interface 2280 may include one or more input and/or output communication interfaces to permit data to be exchanged with a network, communication network servers, computer systems, and/or any other electronic devices described herein.

In many embodiments, the base station 120 may further comprise a memory 2260. The memory 2260 can include, without limitation, local and/or network accessible storage, a disk drive, a drive array, an optical storage device, a solid-state storage device, such as a RAM, and/or a ROM, which can be programmable, flash-updateable, and/or the like. Such storage devices may be configured to implement any appropriate data stores, including without limitation, various file systems, database structures, and/or the like.

The memory 2260 of the base station 120 also may comprise software elements (not shown in FIG. 22), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 2260 that are executable by the base station 120 (and/or processor(s) 2210 or DSP 2220 within base station 120). In some embodiments, then, such code and/or instructions can be used to configure and/or adapt a general-purpose computer (or other device) to perform one or more operations in accordance with the described methods.

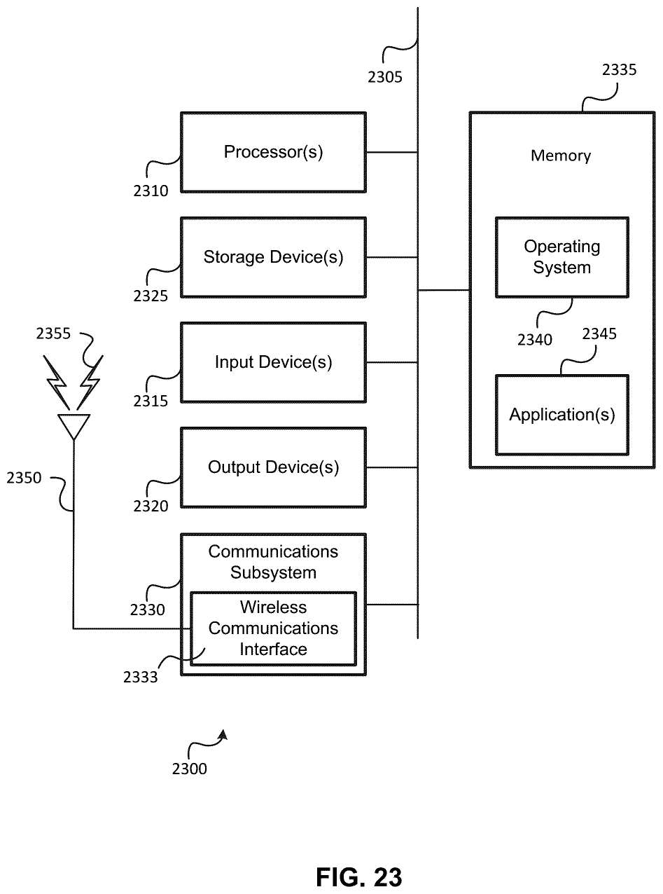

FIG. 23 is a block diagram of an embodiment of a computer system 2300, which may be used, in whole or in part, to provide the functions of one or more network components as described in the embodiments herein (e.g., location server 160 of FIG. 1). It should be noted that FIG. 23 is meant only to provide a generalized illustration of various components, any or all of which may be utilized as appropriate. FIG. 23, therefore, broadly illustrates how individual system elements may be implemented in a relatively separated or relatively more integrated manner. In addition, it can be noted that components illustrated by FIG. 23 can be localized to a single device and/or distributed among various networked devices, which may be disposed at different geographical locations.

The computer system 2300 is shown comprising hardware elements that can be electrically coupled via a bus 2305 (or may otherwise be in communication, as appropriate). The hardware elements may include processor(s) 2310, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 2300 also may comprise one or more input devices 2315, which may comprise without limitation a mouse, a keyboard, a camera, a microphone, and/or the like; and one or more output devices 2320, which may comprise without limitation a display device, a printer, and/or the like.

The computer system 2300 may further include (and/or be in communication with) one or more non-transitory storage devices 2325, which can comprise, without limitation, local and/or network accessible storage, and/or may comprise, without limitation, a disk drive, a drive array, an optical storage device, a solid-state storage device, such as a RAM and/or ROM, which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 2300 may also include a communications subsystem 2330, which may comprise wireless communication technologies managed and controlled by a wireless communication interface 2333, as well as wired technologies (such as Ethernet, coaxial communications, universal serial bus (USB), and the like). The wireless communication interface 2333 may comprise one or more wireless transceivers that may send and receive wireless signals 2355 (e.g., signals according to 5G NR or LTE) via wireless antenna(s) 2350. Thus the communications subsystem 2330 may comprise a modem, a network card (wireless or wired), an infrared communication device, a wireless communication device, and/or a chipset, and/or the like, which may enable the computer system 2300 to communicate on any or all of the communication networks described herein to any device on the respective network, including a User Equipment (UE), base stations and/or other TRPs, and/or any other electronic devices described herein. Hence, the communications subsystem 2330 may be used to receive and send data as described in the embodiments herein.

In many embodiments, the computer system 2300 will further comprise a working memory 2335, which may comprise a RAM or ROM device, as described above. Software elements, shown as being located within the working memory 2335, may comprise an operating system 2340, device drivers, executable libraries, and/or other code, such as one or more applications 2345, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 2325 described above. In some cases, the storage medium might be incorporated within a computer system, such as computer system 2300. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 2300 and/or might take the form of source and/or installable code, which, upon compilation and/or installation on the computer system 2300 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:
Clause 1. A method of transmitting signals for communication and sensing comprising:
   transmitting, from a communication device, a frequency modulated continuous wave (FMCW) signal within an air interface frame structure having a plurality of resource elements, each resource element defined over a symbol duration in a time domain and a subcarrier in a frequency domain; and
   transmitting, from the communication device, a plurality of orthogonal frequency-division multiplexing (OFDM) signals within the air interface frame structure,
   wherein the FMCW signal occupies a first plurality of resource elements in the air interface frame structure and comprises a FMCW waveform repeated in the time domain and transmitted during a first symbol, over a first plurality of subcarriers of the air interface frame structure, and
   wherein the plurality of OFDM signals occupy a second plurality of resource elements in the air interface frame structure and are transmitted during the first symbol, over a second plurality of subcarriers of the air interface frame structure.
Clause 2. The method of clause 1, wherein:
   the FMCW waveform is repeated α times over a cyclic preamble (CP) portion of the first symbol, α being a positive integer,
   the FMCW waveform is repeated (β−α) times over an OFDM portion of the first symbol, β being a positive integer greater than α,
   the first plurality of resource elements occupied by the FMCW signal comprise 1 out of every (β−α) resource elements over the first symbol in a resource block of the air interface frame structure, and
   the second plurality of resource elements occupied by the OFDM signal comprise ((β−α)−1) out of every (β−α) resource elements over the first symbol in the resource block of the air interface frame structure.
Clause 3. The method of clause 1, wherein:
   the FMCW waveform is repeated (α+γ) times over a cyclic preamble (CP) portion of the first symbol, α being a positive integer, and γ being a positive fraction,
   the FMCW waveform is repeated (β−α) times over an OFDM portion of the first symbol, β being a positive integer greater than α,
   the first plurality of resource elements occupied by the FMCW signal comprise 1 out of every (β−α) resource elements in a resource block of the air interface frame structure, and
   the second plurality of resource elements occupied by the OFDM signal comprise ((β−α)−1) out of every (β−α) resource elements in the resource block of the air interface frame structure.
Clause 4. The method of any of clauses 1-3, wherein:
   the first plurality of resource elements form part of a comb-N pattern spanning L symbols within the air interface frame structure, L and N being positive, non-zero integers, and
   the comb-N pattern is occupied by OFDM signals and FMCW signals transmitted from a plurality of communication devices, including the communication device and one or more other communication devices.
Clause 5. The method of clause 4, wherein FMCW signals from the plurality of communication devices are used for multi-device sensing of a target.
Clause 6. The method of clause 4 or 5, wherein FMCW signals from each of the plurality of communication devices occupy a different frequency offset portion of the comb-N pattern.
Clause 7. The method of any of clauses 4-6, wherein the comb-N pattern comprises an existing positioning reference signal (PRS) comb-based pattern defined according to an air interface standard.
Clause 8. The method of clause 7, wherein the air interface standard comprises a 3rd Generation Partnership Project (3GPP) Release 16 standard.
Clause 9. The method of any of clauses 4-6, wherein the comb-N pattern comprises a symmetrical structure.
Clause 10. The method of clause 9, wherein the symmetrical structure comprises a center symbol and one or more pairs of symmetric symbols.
Clause 11. The method of any of clauses 1-10, wherein the transmitting the FMCW signal and the transmitting the plurality of OFDM signals comprise:
   generating the FMCW signal and the plurality of OFDM signals in digital form, as a digital signal;
   converting the digital signal to an analog signal; and
   transmitting a radio frequency (RF) signal based on the analog signal.
Clause 12. The method of any of clauses 1-10, wherein the transmitting the FMCW signal and the transmitting the plurality of OFDM signals comprise:
   generating the FMCW signal as a first analog signal;
   generating the plurality of OFDM signals as a digital signal;
   converting the digital signal to a second analog signal;
   combining the first analog signal and the second analog signal, to generate a combined analog signal; and
   transmitting a radio frequency (RF) signal based on the combined analog signal.
Clause 13. The method of clause 12, further comprising time-aligning the first analog signal and the second analog signal prior to the combining the first analog signal and the second analog signal.
Clause 14. The method of any of clauses 1-13, wherein the communication device comprises a base station, and the FMCW signal and the plurality of OFDM signals form a downlink transmission from the base station.
Clause 15. The method of any of clauses 1-13, wherein the communication device comprises a user equipment (UE), and the FMCW signal and the plurality of OFDM signals form an uplink transmission from the UE.
Clause 16. A device for transmitting signals for communication and sensing comprising:
   a memory;
   one or more processors coupled to the memory;
   a digital-to-analog (D/A) converter coupled to the one or more processors; and
   one or more antennas coupled to the D/A converter, wherein:
   the one or more processors are configured to generate a digital signal comprising (1) a frequency modulated continuous wave (FMCW) signal within an air interface frame structure having a plurality of resource elements, each resource element defined over a symbol duration in a time domain and a subcarrier in a frequency domain, and (2) a plurality of orthogonal frequency-division multiplexing (OFDM) signals within the air interface frame structure,
   the FMCW signal occupies a first plurality of resource elements in the air interface frame structure and comprises a FMCW waveform repeated in the time domain and transmitted during a first symbol, over a first plurality of subcarriers of the air interface frame structure,
   the plurality of OFDM signals occupy a second plurality of resource elements in the air interface frame structure and is transmitted during the first symbol, over a second plurality of subcarriers of the air interface frame structure, and
   the D/A converter is configured generate an analog signal based on the digital signal, and
   the one or more antennas are configured to transmit a radio frequency (RF) signal based on the analog signal.
Clause 17. A device for transmitting signals for communication and sensing comprising:
   a memory;
   one or more processors coupled to the memory;
   a digital-to-analog (D/A) converter coupled to the one or more processors;
   a frequency modulated continuous wave (FMCW) signal generator;
   a combiner coupled to the D/A converter and the FMCW signal generator; and
   one or more antennas coupled to the combiner, wherein:
   the FMCW signal generator is configured to generate, as a first analog signal, a FMCW signal within an air interface frame structure having a plurality of resource elements, each resource element defined over a symbol duration in a time domain and a subcarrier in a frequency domain, the FMCW signal occupying a first plurality of resource elements in the air interface frame structure and comprising a FMCW waveform repeated in the time domain and transmitted during a first symbol, over a first plurality of subcarriers of the air interface frame structure,
   the one or more processors are configured to generate, as a digital signal, a plurality of orthogonal frequency-division multiplexing (OFDM) signals within the air interface frame structure, the plurality of OFDM signals occupying a second plurality of resource elements in the air interface frame structure and is transmitted during the first symbol, over a second plurality of subcarriers of the air interface frame structure,
   the D/A converter is configured to generate a second analog signal based on the digital signal,
   the combiner is configured to generate a combined analog signal based on first analog signal and the second analog signal, and
   the one or more antennas are configured to transmit a radio frequency (RF) signal based on the combined analog signal.
Clause 18. A method for receiving signals for communication and sensing comprising:
   receiving, at a communication device, a frequency modulated continuous wave (FMCW) signal within an air interface frame structure having a plurality of resource elements, each resource element defined over a symbol duration in a time domain and a subcarrier in a frequency domain;
   receiving, at the communication device, a plurality of orthogonal frequency-division multiplexing (OFDM) signals within the air interface frame structure;
   generating, at the communication device, one or more of a range estimate, a Doppler estimate, and/or an Angle of Arrival (AoA) estimate based on the FMCW signal; and
   generating, at the communication device, demodulated data symbols based on the plurality of OFDM signals, wherein:
   the FMCW signal occupies a first plurality of resource elements in the air interface frame structure and comprises a FMCW waveform repeated in the time domain and transmitted during a first symbol, over a first plurality of subcarriers of the air interface frame structure, and
   wherein the plurality of OFDM signals occupy a second plurality of resource elements in the air interface frame structure and are transmitted during the first symbol, over a second plurality of subcarriers of the air interface frame structure.
Clause 19. A device for receiving signals for communication and sensing comprising:
   one or more antennas;
   an analog-to-digital (A/D) converter coupled to the one or more antennas;
   one or more processors coupled to the A/D converter; and
   a memory coupled to the one or more processors, wherein:
   the one or more antennas are configured to receive a radio frequency (RF) signal, the RF signal comprising (1) a frequency modulated continuous wave (FMCW) signal within an air interface frame structure having a plurality of resource elements, each resource element defined over a symbol duration in a time domain and a subcarrier in a frequency domain, and (2) a plurality of orthogonal frequency-division multiplexing (OFDM) signals within the air interface frame structure, wherein:
   the FMCW signal occupies a first plurality of resource elements in the air interface frame structure and comprises a FMCW waveform repeated in the time domain and transmitted during a first symbol, over a first plurality of subcarriers of the air interface frame structure,
   the plurality of OFDM signals occupy a second plurality of resource elements in the air interface frame structure and is transmitted during the first symbol, over a second plurality of subcarriers of the air interface frame structure,
   the A/D converter is configured to generate a digital signal based on the RF signal, and the one or more processors are configured receive the digital signal and
   (1) generate one or more of a range estimate, a Doppler estimate, and/or an Angle of Arrival (AoA) estimate based on the FMCW signal as represented in the digital signal and (2) generate demodulated data symbols based on the plurality of OFDM signals as represented in the digital signal.
Clause 20. A device for receiving signals for communication and sensing comprising:
   one or more antennas;
   a signal splitter;
   a frequency modulated continuous wave (FMCW) receiver coupled to the signal splitter;
   an analog-to-digital (A/D) converter coupled to the signal splitter;
   one or more processors coupled to the A/D converter; and
   a memory coupled to the one or more processors, wherein:
   the one or more antennas are configured to receive a radio frequency (RF) signal, the RF signal comprising (1) a frequency modulated continuous wave (FMCW) signal within an air interface frame structure having a plurality of resource elements, each resource element defined over a symbol duration in a time domain and a subcarrier in a frequency domain, and (2) a plurality of orthogonal frequency-division multiplexing (OFDM) signals within the air interface frame structure, wherein:
   the FMCW signal occupies a first plurality of resource elements in the air interface frame structure and comprises a FMCW waveform repeated in the time domain and transmitted during a first symbol, over a first plurality of subcarriers of the air interface frame structure,
   the plurality of OFDM signals occupy a second plurality of resource elements in the air interface frame structure and is transmitted during the first symbol, over a second plurality of subcarriers of the air interface frame structure,
   the signal splitter is configured to generate a first split signal and a second split signal based on the RF signal,
   the FMCW receiver is configured to generate one or more of a range estimate, a Doppler estimate, and/or an Angle of Arrival (AoA) estimate based on the FMCW signal as represented in the first split signal,
   the A/D converter is configured to generate a digital signal based on the second split signal, and
   the one or more processors are configured to generate demodulated data symbols based on the plurality of OFDM signals as represented in the digital signal.

What is claimed is:

1. A method of transmitting signals for communication and sensing comprising:
transmitting, from a communication device, a frequency modulated continuous wave (FMCW) signal within an air interface frame structure having a plurality of resource elements, each resource element defined over a symbol duration in a time domain and a subcarrier in a frequency domain; and
transmitting, from the communication device, a plurality of orthogonal frequency-division multiplexing (OFDM) signals within the air interface frame structure,
wherein the FMCW signal occupies a first plurality of resource elements in the air interface frame structure and comprises a FMCW waveform repeated in the time domain and transmitted during a first symbol, over a first plurality of subcarriers of the air interface frame structure, and
wherein the plurality of OFDM signals occupy a second plurality of resource elements in the air interface frame structure and are transmitted during the first symbol, over a second plurality of subcarriers of the air interface frame structure.

2. The method of claim 1, wherein:
the FMCW waveform is repeated α times over a cyclic preamble (CP) portion of the first symbol, α being a positive integer,
the FMCW waveform is repeated (β−α) times over an OFDM portion of the first symbol, β being a positive integer greater than α,
the first plurality of resource elements occupied by the FMCW signal comprise 1 out of every (β−α) resource elements over the first symbol in a resource block of the air interface frame structure, and
the second plurality of resource elements occupied by the OFDM signal comprise ((β−α)−1) out of every (β−α) resource elements over the first symbol in the resource block of the air interface frame structure.

3. The method of claim 1, wherein:
the FMCW waveform is repeated (α+γ) times over a cyclic preamble (CP) portion of the first symbol, α being a positive integer, and γ being a positive fraction,
the FMCW waveform is repeated (β−α) times over an OFDM portion of the first symbol, β being a positive integer greater than α,
the first plurality of resource elements occupied by the FMCW signal comprise 1 out of every (β−α) resource elements in a resource block of the air interface frame structure, and
the second plurality of resource elements occupied by the OFDM signal comprise ((β−α)−1) out of every (β−α) resource elements in the resource block of the air interface frame structure.

4. The method of claim 1, wherein:
the first plurality of resource elements form part of a comb-N pattern spanning L symbols within the air interface frame structure, L and N being positive, non-zero integers, and
the comb-N pattern is occupied by OFDM signals and FMCW signals transmitted from a plurality of communication devices, including the communication device and one or more other communication devices.

5. The method of claim 4, wherein FMCW signals from the plurality of communication devices are used for multi-device sensing of a target.

6. The method of claim 4, wherein FMCW signals from each of the plurality of communication devices occupy a different frequency offset portion of the comb-N pattern.

7. The method of claim 4, wherein the comb-N pattern comprises an existing positioning reference signal (PRS) comb-based pattern defined according to an air interface standard.

8. The method of claim 7, wherein the air interface standard comprises a 3rd Generation Partnership Project (3GPP) Release 16 standard.

9. The method of claim 4, wherein the comb-N pattern comprises a symmetrical structure.

10. The method of claim 9, wherein the symmetrical structure comprises a center symbol and one or more pairs of symmetric symbols.

11. The method of claim 1, wherein the transmitting the FMCW signal and the transmitting the plurality of OFDM signals comprise:
generating the FMCW signal and the plurality of OFDM signals in digital form, as a digital signal;
converting the digital signal to an analog signal; and
transmitting a radio frequency (RF) signal based on the analog signal.

12. The method of claim 1, wherein the transmitting the FMCW signal and the transmitting the plurality of OFDM signals comprise:
generating the FMCW signal as a first analog signal;
generating the plurality of OFDM signals as a digital signal;
converting the digital signal to a second analog signal;
combining the first analog signal and the second analog signal, to generate a combined analog signal; and
transmitting a radio frequency (RF) signal based on the combined analog signal.

13. The method of claim 12, further comprising time-aligning the first analog signal and the second analog signal prior to the combining the first analog signal and the second analog signal.

14. The method of claim 1, wherein the communication device comprises a base station, and the FMCW signal and the plurality of OFDM signals form a downlink transmission from the base station.

15. The method of claim 1, wherein the communication device comprises a user equipment (UE), and the FMCW signal and the plurality of OFDM signals form an uplink transmission from the UE.

16. A device for transmitting signals for communication and sensing comprising:
a memory;
one or more processors coupled to the memory;
a digital-to-analog (D/A) converter coupled to the one or more processors; and
one or more antennas coupled to the D/A converter, wherein:
the one or more processors are configured to generate a digital signal comprising (1) a frequency modulated continuous wave (FMCW) signal within an air interface frame structure having a plurality of resource elements, each resource element defined over a symbol duration in a time domain and a subcarrier in a frequency domain, and (2) a plurality of orthogonal frequency-division multiplexing (OFDM) signals within the air interface frame structure,
the FMCW signal occupies a first plurality of resource elements in the air interface frame structure and comprises a FMCW waveform repeated in the time domain and transmitted during a first symbol, over a first plurality of subcarriers of the air interface frame structure,
the plurality of OFDM signals occupy a second plurality of resource elements in the air interface frame structure and is transmitted during the first symbol, over a second plurality of subcarriers of the air interface frame structure, and
the D/A converter is configured generate an analog signal based on the digital signal, and
the one or more antennas are configured to transmit a radio frequency (RF) signal based on the analog signal.

17. A device for transmitting signals for communication and sensing comprising:
a memory;
one or more processors coupled to the memory;
a digital-to-analog (D/A) converter coupled to the one or more processors;
a frequency modulated continuous wave (FMCW) signal generator;
a combiner coupled to the D/A converter and the FMCW signal generator; and
one or more antennas coupled to the combiner, wherein:
the FMCW signal generator is configured to generate, as a first analog signal, a FMCW signal within an air interface frame structure having a plurality of resource elements, each resource element defined over a symbol duration in a time domain and a subcarrier in a frequency domain, the FMCW signal occupying a first plurality of resource elements in the air interface frame structure and comprising a FMCW waveform repeated in the time domain and transmitted during a first symbol, over a first plurality of subcarriers of the air interface frame structure,
the one or more processors are configured to generate, as a digital signal, a plurality of orthogonal frequency-division multiplexing (OFDM) signals within the air interface frame structure, the plurality of OFDM signals occupying a second plurality of resource elements in the air interface frame structure and is transmitted during the first symbol, over a second plurality of subcarriers of the air interface frame structure,
the D/A converter is configured to generate a second analog signal based on the digital signal,
the combiner is configured to generate a combined analog signal based on first analog signal and the second analog signal, and
the one or more antennas are configured to transmit a radio frequency (RF) signal based on the combined analog signal.

18. A method for receiving signals for communication and sensing comprising:
receiving, at a communication device, a frequency modulated continuous wave (FMCW) signal within an air interface frame structure having a plurality of resource elements, each resource element defined over a symbol duration in a time domain and a subcarrier in a frequency domain;
receiving, at the communication device, a plurality of orthogonal frequency-division multiplexing (OFDM) signals within the air interface frame structure;
generating, at the communication device, one or more of a range estimate, a Doppler estimate, and/or an Angle of Arrival (AoA) estimate based on the FMCW signal; and
generating, at the communication device, demodulated data symbols based on the plurality of OFDM signals, wherein:
the FMCW signal occupies a first plurality of resource elements in the air interface frame structure and comprises a FMCW waveform repeated in the time domain and transmitted during a first symbol, over a first plurality of subcarriers of the air interface frame structure, and
wherein the plurality of OFDM signals occupy a second plurality of resource elements in the air interface frame structure and are transmitted during the first symbol, over a second plurality of subcarriers of the air interface frame structure.

19. A device for receiving signals for communication and sensing comprising:
one or more antennas;
an analog-to-digital (A/D) converter coupled to the one or more antennas;
one or more processors coupled to the A/D converter; and
a memory coupled to the one or more processors, wherein:
the one or more antennas are configured to receive a radio frequency (RF) signal, the RF signal comprising (1) a frequency modulated continuous wave (FMCW) signal within an air interface frame structure having a plurality of resource elements, each resource element defined over a symbol duration in a time domain and a subcarrier in a frequency domain, and (2) a plurality of orthogonal frequency-division multiplexing (OFDM) signals within the air interface frame structure, wherein:
the FMCW signal occupies a first plurality of resource elements in the air interface frame structure and comprises a FMCW waveform repeated in the time domain and transmitted during a first symbol, over a first plurality of subcarriers of the air interface frame structure,
the plurality of OFDM signals occupy a second plurality of resource elements in the air interface frame structure and is transmitted during the first symbol, over a second plurality of subcarriers of the air interface frame structure,
the A/D converter is configured to generate a digital signal based on the RF signal, and
the one or more processors are configured receive the digital signal and (1) generate one or more of a range estimate, a Doppler estimate, and/or an Angle of Arrival (AoA) estimate based on the FMCW signal as represented in the digital signal and (2) generate demodulated data symbols based on the plurality of OFDM signals as represented in the digital signal.

20. A device for receiving signals for communication and sensing comprising:
one or more antennas;
a signal splitter;
a frequency modulated continuous wave (FMCW) receiver coupled to the signal splitter;
an analog-to-digital (A/D) converter coupled to the signal splitter;
one or more processors coupled to the A/D converter; and
a memory coupled to the one or more processors, wherein:
the one or more antennas are configured to receive a radio frequency (RF) signal, the RF signal comprising (1) a frequency modulated continuous wave (FMCW) signal within an air interface frame structure having a plurality of resource elements, each resource element defined over a symbol duration in a time domain and a subcarrier in a frequency domain, and (2) a plurality of orthogonal frequency-division multiplexing (OFDM) signals within the air interface frame structure, wherein:
the FMCW signal occupies a first plurality of resource elements in the air interface frame structure and comprises a FMCW waveform repeated in the time domain and transmitted during a first symbol, over a first plurality of subcarriers of the air interface frame structure,
the plurality of OFDM signals occupy a second plurality of resource elements in the air interface frame structure and is transmitted during the first symbol, over a second plurality of subcarriers of the air interface frame structure,
the signal splitter is configured to generate a first split signal and a second split signal based on the RF signal,
the FMCW receiver is configured to generate one or more of a range estimate, a Doppler estimate, and/or an Angle of Arrival (AoA) estimate based on the FMCW signal as represented in the first split signal,
the A/D converter is configured to generate a digital signal based on the second split signal, and
the one or more processors are configured to generate demodulated data symbols based on the plurality of OFDM signals as represented in the digital signal.
